(19) United States
(12) Patent Application Publication
(10) Pub. No.: US 2016/0302177 A1
(43) Pub. Date: Oct. 13, 2016

(54) METHOD AND APPARATUS FOR INDICATING ACTIVATION/DEACTIVATION OF SERVING CELL IN WIRELESS COMMUNICATION SYSTEM USING MULTIPLE COMPONENT CARRIER

(71) Applicant: Innovative Technology Lab Co., Ltd., Seoul (KR)

(72) Inventors: Ki Bum KWON, Seoul (KR); Dong Hyun PARK, Seoul (KR)

(21) Appl. No.: 15/094,875

(22) Filed: Apr. 8, 2016

(30) Foreign Application Priority Data
Apr. 10, 2015 (KR) 10-2015-0050890
May 15, 2015 (KR) 10-2015-0068344

(51) Int. Cl. H04W 72/04; H04W 16/32; H04W 8/22

(52) U.S. Cl. CPC H04W 72/042; H04W 8/22; H04W 16/32

(57) ABSTRACT

A method for controlling activation of secondary serving cells by a User Equipment (UE) includes: receiving, from a base station, a Radio Resource Control (RRC) message including cell configuration information for the UE, the cell configuration information for the UE including configuration information of a maximum of 32 serving cells; receiving, from the base station, activation/deactivation Media Access Control (MAC) information associated with secondary serving cells configured for the UE, the activation/deactivation MAC information including a 4-octet MAC control element (CE) and a Logical Channel Identifier associated with the 4-octet MAC CE, at least part of the 4-octet MAC CE being associated with an activation or deactivation of the secondary serving cells configured for the UE; and controlling activation/deactivation states of the secondary serving cells configured for the UE according to values of the at least part of the 4-octet MAC CE.

### CROSS-REFERENCE TO RELATED APPLICATIONS

This application claims priority from and the benefit of Korean Patent Application Nos. 10-2015-0050890, filed on Apr. 10, 2015, and 10-2015-0068344, filed on May 15, 2015, each of which is hereby incorporated by reference in its entirety.

### BACKGROUND

1. Field

The present disclosure relates to wireless communication and, more particularly, to a method and apparatus for indicating activation/deactivation of a serving cell when carrier aggregation is used in a wireless communication system that uses multiple component carriers.

2. Discussion of the Background

In a wireless communication system that uses carrier aggregation, at least one serving cell of which a frequency band does not overlap one another may be configured for each base station (BS), and each of the serving cells may be operated in an activated or deactivated state. A Primary (serving) Cell (PCell) that may be configurable in an existing carrier aggregation scheme is a serving cell that basically requires a Physical Uplink Control Channel (PUCCH), and may not be deactivated. Conversely, a Secondary (serving) Cell (SCell) is a serving cell in which a PUCCH may not be configured, and deactivation is possible.

However, when 5 or more component carriers are aggregated, transmitting a PUCCH through a single PCell may be difficult to handle the amount of Uplink Control Information (UCI) that includes feedback information which a BS requires to improve radio link efficiency in association with a plurality of downlink component carriers. Therefore, an SCell that is capable of configuring a PUCCH is under discussion. However, an existing activation/deactivation Medium Access Control (MAC) control element message that includes activation/deactivation indicators with respect to serving cells may include activation/deactivation indicators with respect to a maximum of 8 serving cells. Therefore, when 8 or more serving cells are configured for a User Equipment (UE), the existing activation/deactivation MAC CE message may not be capable of indicating activation/deactivation with respect to the corresponding serving cells.

Accordingly, to solve the drawback, there is a desire for a method of activating/deactivating an SCell that is capable of configuring a PUCCH, and a method of indicating activation/deactivation with respect to increasing SCells.

### SUMMARY

Exemplary embodiments provide a method and apparatus for indicating activation/deactivation of a serving cell when carrier aggregation is used in a wireless communication system that uses extended multiple component carriers.

An exemplary embodiment provides a method for controlling activation of secondary serving cells by a User Equipment (UE), the method including: receiving, from a base station, a Radio Resource Control (RRC) message including cell configuration information for the UE, the cell configuration information for the UE including configuration information of a maximum of 32 serving cells; receiving, from the base station, activation/deactivation Media Access Control (MAC) information associated with secondary serving cells configured for the UE, the activation/deactivation MAC information including a 4-octet MAC control element (CE) and a Logical Channel Identifier associated with the 4-octet MAC CE, at least part of the 4-octet MAC CE being associated with an activation or deactivation of the secondary serving cells configured for the UE; and controlling activation/deactivation states of the secondary serving cells configured for the UE according to values of the at least part of the 4-octet MAC CE.

An exemplary embodiment provides a system-on-chip (SoC) for a User Equipment (UE) to control activation of secondary serving cells, the SoC including: a processor configured to: receive a Radio Resource Control (RRC) message including cell configuration information for the UE, the cell configuration information for the UE including configuration information of a maximum of 32 serving cells; receive activation/deactivation Media Access Control (MAC) information associated with secondary serving cells configured for the UE, the activation/deactivation MAC information including a 4-octet MAC control element (CE) and a Logical Channel Identifier associated with the 4-octet MAC CE, at least part of the 4-octet MAC CE being associated with an activation or deactivation of the secondary serving cells configured for the UE; and control activation/deactivation states of the secondary serving cells configured for the UE according to values of the at least part of the 4-octet MAC CE.

An exemplary embodiment provides a method for controlling activation of secondary serving cells by a system for a base station, the method including: configuring secondary serving cells for a User Equipment (UE), a serving cell index of at least one of the secondary serving cells is greater than seven; transmitting, to the UE, a Radio Resource Control (RRC) message including cell configuration information for the UE, the cell configuration information for the UE including configuration information of a maximum of 32 serving cells; setting values of at least part of a 4-octet Media Access Control (MAC) control element (CE) for controlling activation/deactivation states of the secondary serving cells configured for the UE; and transmitting, to the UE, activation/deactivation MAC information associated with the secondary serving cells configured for the UE, the activation/deactivation MAC information including the 4-octet MAC CE and a Logical Channel Identifier associated with the 4-octet MAC CE, the values of the at least part of the 4-octet MAC CE being associated with an activation or deactivation of the secondary serving cells configured for the UE.

### BRIEF DESCRIPTION OF THE DRAWINGS

FIG. 1 is a block diagram illustrating a wireless communication system.

FIG. 2 is a diagram illustrating a method of indicating activation/deactivation of serving cells according to an embodiment of the present invention.

FIG. 3 is a diagram illustrating an activation/deactivation MAC CE according to an embodiment of the present invention.

FIG. 4 is a diagram illustrating a MAC PDU according to an embodiment of the present invention.

FIG. 5 is a diagram illustrating a MAC sub-header according to an embodiment of the present invention.

FIG. 6 is a flowchart illustrating the operations of a User Equipment (UE) according to an embodiment of the present invention.

FIG. 7 is a diagram illustrating an activation/deactivation MAC CE according to another embodiment of the present invention.

FIG. 8 is a flowchart illustrating the operations of a UE according to the embodiment of FIG. 7.

FIG. 9 is a diagram illustrating a method of indicating activation/deactivation of serving cells according to another embodiment of the present invention.

FIG. 10 is a diagram illustrating an activation/deactivation MAC CE according to the embodiment of FIG. 9.

FIG. 11 is a flowchart illustrating the operations of a UE according to the embodiment of FIG. 10.

FIG. 12 is a diagram illustrating an activation/deactivation MAC CE according to another embodiment of the present invention.

FIG. 13 is a flowchart illustrating the operations of a UE according to the embodiment of FIG. 12.

FIG. 14 is a diagram illustrating an activation/deactivation MAC CE according to another embodiment of the present invention.

FIG. 15 is a flowchart illustrating the operations of a UE according to the embodiment of FIG. 14.

FIG. 16, FIG. 17, and FIG. 18 are diagrams illustrating an activation/deactivation MAC CE according to other embodiments of the present invention.

FIG. 19 is a flowchart illustrating the operations of a Base Station (BS) according to an embodiment of the present invention.

FIG. 20 is a block diagram illustrating a wireless communication system according to an embodiment of the present invention.

### DETAILED DESCRIPTION OF THE ILLUSTRATED EMBODIMENTS

Exemplary embodiments of the present invention will be described more fully hereinafter with reference to the accompanying drawings, in which exemplary embodiments of the invention are shown. Throughout the drawings and the detailed description, unless otherwise described, the same drawing reference numerals are understood to refer to the same elements, features, and structures. In describing the exemplary embodiments, detailed description on known configurations or functions may be omitted for clarity and conciseness.

Further, the description described herein is related to a wireless communication network, and an operation performed in a wireless communication network may be performed in a process of controlling a network and transmitting data by a system that controls a wireless network, e.g., a base station, or may be performed in a user equipment connected to the wireless communication network.

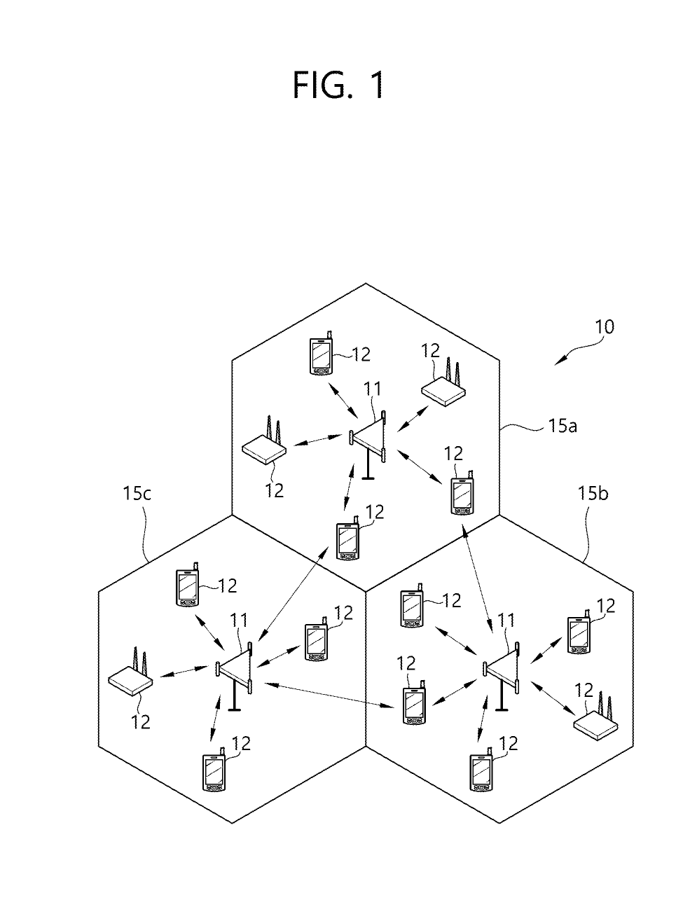

FIG. 1 is a block diagram illustrating a wireless communication system.

A network structure illustrated in FIG. 1 may be a network structure of an Evolved-Universal Mobile Telecommunications System (E-UMTS). The E-UMTS system may include a Long Term Evolution (LTE) system, a LTE-Advanced (LTE-A) system, a 3rd Generation Partnership Project (3GPP) Standard-based network structure which satisfies the International Mobile Telecommunication-2020 (IMT-2020) standard that is defined by International Telecommunication Union-Radio communication sector (ITU-R), and the like.

Referring to FIG. 1, in a wireless communication system 10, a Base Station (BS) 11 and a User Equipment (UE) 12 may wirelessly perform transmission and reception of data.

A BS 11 of the wireless communication system 10 may provide a communication service to a UE existing in a transmission coverage of the BS 11, through a predetermined frequency band. The coverage within which a BS provides a service is also referred to as a site. The site may include various areas 15a, 15b, and 15c, which may be referred to as sectors. The sectors included in the site may be identified based on different identifier from one another. Each sector 15a, 15b, and 15c may be construed as a part of the area that the BS 11 covers.

A base station 11 communicates with User Equipment (UE) 12 and may be referred to as eNB (evolved-NodeB), BTS (Base Transceiver System), Access Point, femto base station, Home nodeB, relay and Remote Radio Head (RRH).

User equipment 12 (mobile station, MS) may be located at a certain location or mobile, and may also be referred to as different terms, including UE (user equipment), MT (mobile terminal), UT (user terminal), SS (subscriber station), wireless device, PDA (personal digital assistant), wireless modem, and handheld device.

A base station 11 can be also referred a cell, which inclusively is referred to various coverage areas, such as mega cell, macro cell, micro cell, pico cell, and femto cell. A cell may be used as a term for indicating a frequency band that a BS provides, a coverage of a BS, or a BS.

Hereinafter, the term downlink refers to communication from a base station 11 to a UE 12, and the term uplink refers to communication from a UE 12 to a base station 11. For downlink, a transmitter may be part of a base station 11, and a receiver may be part of a UE 12. For uplink, a transmitter may be part of a UE 12 and a receiver may be part of a base station 11.

There is no limitation in the multiple access method applied to a wireless communication system. Diverse methods can be used, including CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA. Uplink transmission and downlink transmission can use either TDD (Time Division Duplex), which uses different time locations for transmissions, or FDD (Frequency Division Duplex), which uses different frequencies for transmissions.

At least one serving cell may be configured for a UE according to carrier aggregation (CA) scheme, by a base station. The CA scheme is a technology to effectively use divided narrow bands, and the CA scheme may provide an effect that a base station uses a logically wide band by aggregating physically continuous or non-continuous bands in a frequency domain.

When CA is configured in the UE, the UE may have a single Radio Resource Control (RRC) connection with a network. In the case of the establishment/re-establishment/handover of the RRC connection, a predetermined serving cell may provide Non-Access Stratum (NAS) mobility information (e.g., Tracking Area ID (TAI)). Hereinafter, the predetermined serving cell is referred to as a Primary (serving) Cell (PCell). The PCell is formed of a pair of a Downlink Primary Component Carrier (DL PCC) and an Uplink Primary Component Carrier (UL PCC). In this instance, based on the hardware capability of a UE (UE capability), Secondary (serving) Cells (SCells) together with the PCell may be configured as a serving cell set. The SCell may be formed of only a Downlink Secondary Component Carrier (DL SCC), or may be formed of a pair of the DL SCC and an Uplink Secondary Component Carrier (UL SCC).

When CA is configured in the UE as described above, to optimize the consumption of a battery of the corresponding UE, an activation/deactivation mechanism with respect to an SCell may be supported. Here, the PCell is a serving cell that basically requires a Physical Uplink Control CHannel (PUCCH), and thus, the PCell may not be deactivated.

When an SCell is deactivated, the UE may neither monitor nor receive a Physical Downlink Control Channel (PDCCH) or a Physical Downlink Shared Channel (PDSCH) corresponding to the SCell, and may not perform any transmission through an uplink corresponding to the SCell. Also, the UE may not need to measure a Channel Quality Indicator (CQI) with respect to the deactivated SCell. Conversely, when the SCell is activated, the UE needs to receive a PDCCH and a PDSCH. Also, the UE needs to measure a CQI. However, this may be applied only when the corresponding UE is configured to monitor a PDCCH with respect to the corresponding SCell.

The activation/deactivation mechanism is based on a combination of a Medium Access Control (MAC) Control Element (CE) and a deactivation timer. The MAC CE expresses the activation/deactivation of each SCell by a single bit, and ‘0’ indicates deactivation and ‘1’ indicates activation. The BS may independently indicate the activation/deactivation of SCells by using a bit corresponding to each SCell. The deactivation timer is configured and maintained for each SCell. Although all of the SCells configured for the UE commonly have a single identical deactivation timer value, the deactivation timer may be independently operated for each SCell. The deactivation timer value may be configured through an RRC signaling.

When the UE receives an RRC reconfiguration message that does not include Mobility Control Information (MCI) and an SCell that is added through the RRC reconfiguration message exists, an initial state thereof is a ‘deactivated’ state. The activation/deactivation state of an SCell, which is reconfigured through the RRC reconfiguration message or that is not changed, may not be changed. That is, the state may be maintained. When the UE receives an RRC reconfiguration message including the MCI, that is, in the case of handover, all the SCells are changed to the ‘deactivated’ state.

However, an existing activation/deactivation MAC CE message including activation/deactivation indicators with respect to serving cells configured for a UE may include activation/deactivation indicators with respect to a maximum of 8 serving cells. Therefore, when 8 or more serving cells are configured for a UE, the existing activation/deactivation MAC CE message may have trouble in indicating activation/deactivation with respect to the corresponding serving cells. Accordingly, hereinafter, when a UE is configured with a maximum of 32 serving cells, a method of indicating activation/deactivation of the serving cells will be described.

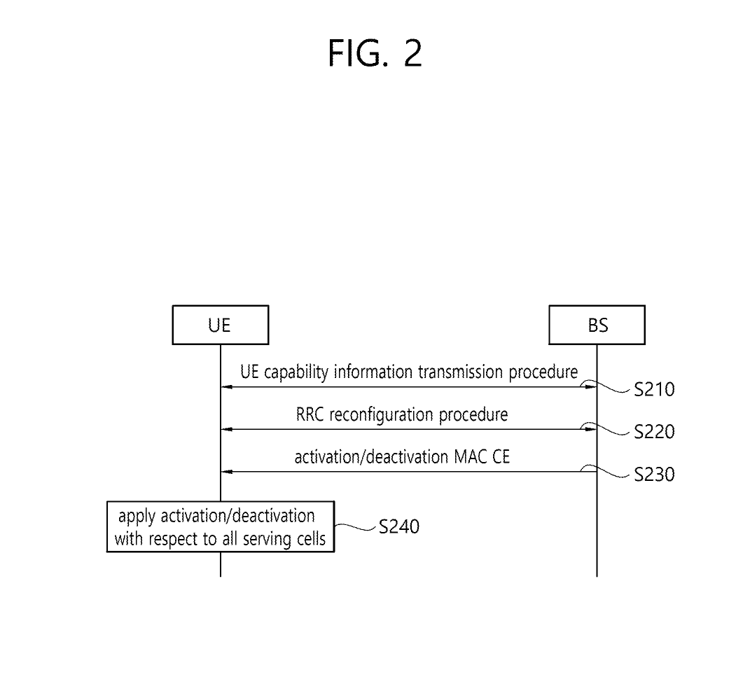

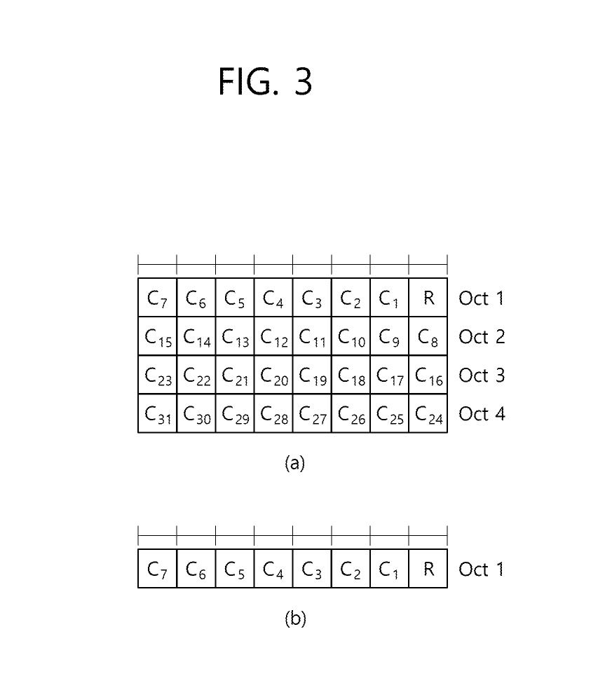

FIG. 2 is a diagram illustrating a method of indicating activation/deactivation of serving cells according to an embodiment of the present invention. FIGS. 3 to 5 are diagrams illustrating an activation/deactivation MAC CE, a MAC PDU, and a MAC subheader according to an embodiment of the present invention.

According to a first embodiment of the present invention, when it is the situation where a maximum of 32 serving cells are configurable for a single UE, a BS may transmit activation/deactivation information with respect to the serving cells by using an MAC CE format formed of 32 bits. Therefore, when a UE recognizes the situation (the situation where a maximum of 32 serving cells are configurable), the UE may recognize that the activation/deactivation information associated with the serving cells may be transmitted in the MAC CE format of 32 bits. When the UE receives an activation/deactivation message in the MAC CE format of 32 bits, the UE determines the same and activates/deactivates the serving cells configured for the UE.

For example, referring to FIG. 2, when it is difficult to secure the information associated with a predetermined UE (when the information associated with a corresponding UE is not stored in a BS and the information associated with the corresponding UE is not also stored in a Mobility Management Entity (MME)), the BS may request, from the UE through a UE capability transfer procedure, UE capability information including information associated with a frequency band that may be supported by the corresponding UE.

The UE may transmit, to the BS through the UE capability information transfer procedure, UE capability information including information associated with a frequency band that may be supported by the UE, information associated with a combination of frequency bands of which CA is possible (band combination), information associated with a bandwidth that may be supportable in each frequency band (bandwidth combination set), and the like. Here, the information associated with a CA-enable frequency band combination may include the number of component carriers that may be configurable in each frequency band included in the CA-enable frequency band combination, and information associated with whether CA of component carriers in non-contiguous frequency bands is possible. The information may be separated into information associated with an uplink and information associated with a downlink. Here, the component carrier indicates a downlink or uplink band forming a serving cell.

When the UE capability information is received, and the number of downlink or uplink component carriers is 6, or a value greater than or equal to 9, which is obtained by adding the number of component carriers that may be configurable in each frequency band included in at least one frequency band combination out of the CA-enable frequency band combinations, with respect to the entire frequency band combinations, the BS may recognize that a maximum of 32 serving cells may be configured for the corresponding UE. Here, the range applied to 6 component carriers is for supporting a communication environment that evolves from an existing CA environment (system) that supports 5 CCs to a system that supports 5 or more CCs. The range applied to 9 or more component carriers is for supporting a communication system that supports increasing CCs that are greater than or equal to 8 bits, by taking into consideration the structure of a MAC message of 8 bits.

The information associated with the number of component carriers that may be configurable in each frequency band may be defined for each class in Table 1, as provided below. Referring to Table 1, the maximum number of component carriers that may be supported, a maximum aggregated bandwidth, and the like are defined for each class.

TABLE 1

| | Aggregated | | |
|---|---|---|---|
| CA | Transmission | Number of | |
| Bandwidth | Bandwidth | contiguous | Nominal Guard |
| Class | Configuration | CC | Band BW_{GB} |
| A | N_{RB, agg} ≦ 100 | 1 | a₁ BW_{Channel(1)} - 0.5Δf₁ |
| | | | (NOTE 2) |
| B | 25 < N_{RB, agg} ≦ 100 | 2 | 0.05 max(BW_{Channel(1)}, |
| | | | BW_{Channel(2)}) - 0.5Δf₁ |
| C | 100 < N_{RB, agg} ≦ 200 | 2 | 0.05 max(BW_{Channel(1)}, |
| | | | BW_{Channel(2)}) - 0.5Δf₁ |
| D | 200 < N_{RB, agg} ≦ 300 | 3 | 0.05 max(BW_{Channel(1)}, |
| | | | BW_{Channel(2)}, |
| | | | BW_{Channel(3)}) - 0.5Δf₁ |
| E | 300 < N_{RB, agg} ≦ 400 | 4 | Applicable for later |
| F | 400 < N_{RB, agg} ≦ 500 | 5 | Applicable for later |

In Table 1, each of BW_{Channel(1)}), BW_{Channel(2)}, and BW_{Channel(3)} indicates a channel bandwidth of each component carrier. Δf₁ indicates Δf associated with a downlink that has a subcarrier spacing of Δf while Δf₁ associated with an uplink is ‘0’. a₁ is 0.16/1.4 when BW_{Channel(1)} is 1.4 MHz, and is 0.05 with respect to all channel bandwidths for the rest cases.

The UE capability information may include information indicating that a maximum of 6 to 32 serving cells may be configurable for the corresponding UE. In this instance, the information (the information indicating that a maximum of 6 to 32 serving cells may be configurable for the corresponding UE) may be transmitted to the BS only when a maximum of 6 to 32 serving cells are configurable for the corresponding UE. The information may include one value out of 6 to 31 or 32, in the form of the information associated with the maximum number of supportable serving cells or SCells. Therefore, when the information (the information indicating that a maximum of 6 to 32 serving cells are configurable for the corresponding UE) is received, the BS may recognize that the corresponding UE supports a configuration of a maximum of 6 to 32 serving cells.

When 5 or more component carriers are aggregated for a single UE through CA, transmitting a PUCCH through a single PCell may be difficult to handle the amount of Uplink Control Information (UCI) including feedback information that a BS requires to improve radio link efficiency in association with a plurality of downlink component carriers. Therefore, in this instance, two or more serving cells that are capable of transmitting a PUCCH may be configured for the UE. Here, one of the serving cells that are capable of transmitting a PUCCH is a PCell and the other serving cell is an SCell. Hereinafter, the SCell that is capable of transmitting a PUCCH, in addition to the PCell, is referred to as a PUCCH SCell. A SCell configured for the UE may form a cell group by being mapped to the PCell, or may form a cell group by being mapped to the PUCCH SCell. Hereinafter, a cell group including the PCell is referred to as a Primary Cell Group (PCG) and a cell group including a PUCCH SCell is referred to as a PUCCH Secondary Cell Group (PSCG).

The BS may transmit, to the UE, information associated with a mapping relationship between the PCell and/or the PUCCH SCell and SCells, using an RRC signaling. Also, when information associated with a cell group and the mapping relationship have a difference, an independent RRC signal may be defined or a cell group may be fixedly defined based on a serving cell index, so as to support the same. In this instance, when the information associated with the number of cell groups is provided, the range of a serving cell index included in each cell group may be determined based on the information.

The information indicating whether the UE supports the configuration of a PUCCH SCell may be included in the information (UE capability information) that is transmitted when the corresponding UE supports the configuration of a maximum of 32 serving cells, and the number of a maximum number of supportable PUCCH S Cells may also be included. Alternatively, information indicating whether the configuration of a PUCCH SCell is supported may be included as one of the elements of the information associated with each frequency band of the information associated with a CA-enable frequency band combination. Therefore, the BS may determine a frequency band and the number of PUCCH SCells that may be configurable for each frequency band combination. This may be transmitted only when the UE supports a PUCCH SCell.

In addition, information associated with whether the UE supports a simultaneous PUCCH transmission may be included as one of the elements of the information associated with each frequency band included in the information associated with the CA-enable frequency band combination or the information that is transmitted when the corresponding UE supports the configuration of a maximum of 32 serving cells.

Also, the PUCCH SCell may support activation/deactivation. However, while the PUCCH SCell is deactivated, SCells that belong to a corresponding PSCG (that is, SCells that have a mapping relationship with the PUCCH SCell) may be incapable of being activated. Therefore, the PUCCH SCell may not be deactivated while the SCells that belong to the corresponding PSCG are activated. When the UE receives, from the BS, a MAC Protocol Data Unit (PDU) including information indicating the deactivation of a PUCCH SCell which has a mapping relationship with activated SCells, the corresponding UE may discard the MAC PDU.

When the BS recognizes that a maximum of 32 serving cells are capable of being configured for the corresponding UE through the UE capability information transfer procedure of operation S210, or recognizes that a PUCCH SCell is configurable, the BS adds, removes, or reconfigures an SCell for the UE through an RRC reconfiguration procedure in operation S220, and transmits a MAC PDU including an activation/deactivation MAC CE as illustrated in FIG. 3A or 3B, in operation S230.

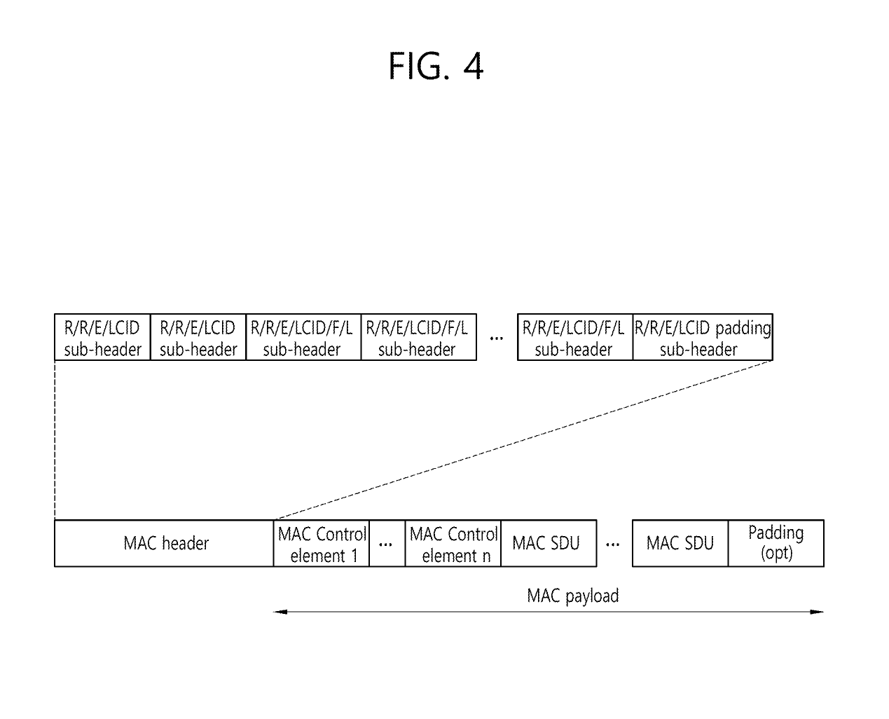

Referring to FIG. 4, the MAC PDU is formed of a single MAC header, ‘0’ or one or more MAC CEs, ‘0’ or one or more MAC Service Data Units (SDUs), and a padding. Here, the MAC header and the MAC SDU have variable lengths, and the padding may be optionally included in the MAC PDU.

The MAC header may be formed of one or more MAC subheaders. Each MAC subheader may correspond to a MAC SDU, a MAC CE, or a padding of the MAC PDU. That is, the subheaders of the MAC PDU may have an identical sequence to the corresponding MAC SDU, MAC CE, and padding.

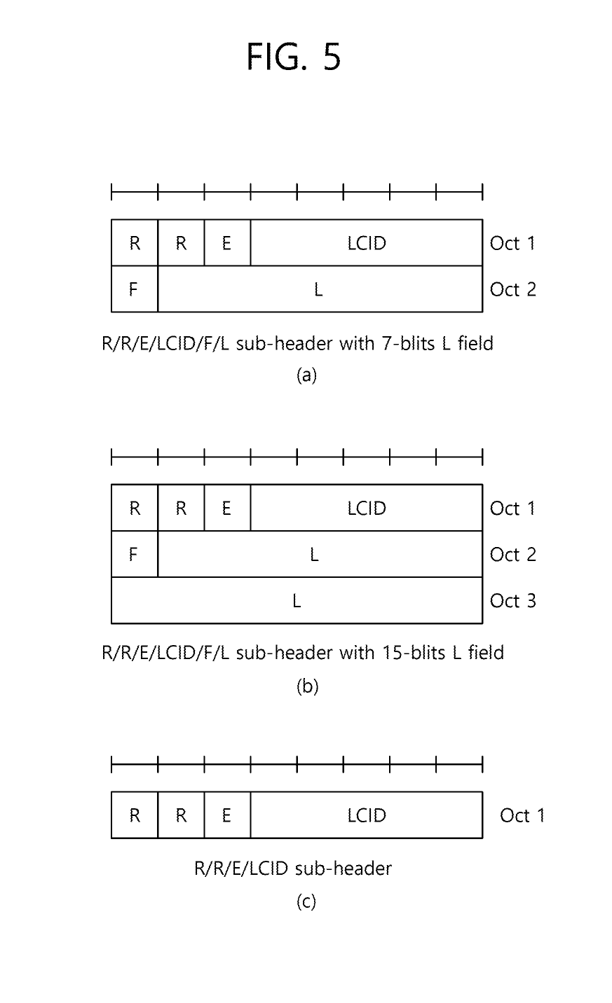

A MAC CE for activation/deactivation of a serving cell may correspond to a MAC subheader that is of a type (R/R/E/LCID type) illustrated in FIG. 5A to FIG. 5C. The MAC subheader may include 6 fields (R, R, E, LCID, F, and L) as illustrated in FIG. 5A and FIG. 5B, or may include 4 fields (R, R, E, and LCID) as illustrated in FIG. 5C. In FIGS. 5A to 5C, a Logical Channel Identifier (ID) (LCID) field is a field for identifying a logical channel of a corresponding MAC SDU, or a type of a corresponding MAC control element or padding. A Length (L) field is a field for identifying the length of a corresponding MAC SDU or the length of a variable-sized MAC control element. A F field is a field for identifying the length of the L field. An Extension (E) field is a field for identifying whether other fields exist in a MAC header. A Reserved (R) field is a reserved field and is set to “0”.

The BS may use an activation/deactivation MAC CE format of 32 bits, as illustrated in FIG. 3A, in the following situations (situation 1 to situation 3). Hereinafter, the activation/deactivation MAC CE of 32 bits is referred to as an extended activation/deactivation MAC CE. For the rest, an activation/deactivation MAC CE format of 8 bits, as illustrated in FIG. 3B, may be used.

Situation 1: when the total number of serving cells that a BS configures for a UE through an RRC reconfiguration procedure is 6 or a value greater than or equal to 9.

In this instance, irrespective of whether a PUCCH SCell is configured, the BS may use the extended activation/deactivation MAC CE format as illustrated in FIG. 3A. In this instance, with respect to the extended activation/deactivation MAC CE, the BS may use LCID (‘11011’) associated with the activation/deactivation MAC CE of 8 bits as it is, out of LCID values listed in Table 2, or may use new LCID (‘11001’) for the extended activation/deactivation MAC CE.

TABLE 2

| Index | LCID values |
|---|---|
| 00000 | CCCH |
| 00001-01010 | Identity of the logical channel |
| 01011-11000 | Reserved |
| 11001 | Extended Activation/Deactivation |
| 11010 | Long DRX Command |
| 11011 | Activation/Deactivation |
| 11100 | UE Contention Resolution Identity |
| 11101 | Timing Advance Command |
| 11110 | DRX Command |
| 11111 | Padding |

Referring to Table 2, an LCID value with respect to the activation/deactivation MAC CE of 32 bits for activation/deactivation of a serving cell may be set to ‘11001’, and an LCID value with respect to the activation/deactivation MAC CE of 8 bits may be set to ‘11011’. Therefore, a MAC CE corresponding to a subheader of a MAC PDU of which the LCID value is set to ‘11001’ may be understood as illustrated in FIG. 3A, and a MAC CE corresponding to a subheader of a MAC PDU of which the LCID value is set to ‘11011’ may be understood as illustrated in FIG. 3B.

In FIGS. 3A and 3B, C₁ is an indicator indicating activation/deactivation of SCells having an index value of ‘1’ when an SCell having the index value of ‘1’ is configured. In the same manner, C₂ is an indicator indicating activation/deactivation of SCells having an index value of ‘2’ when an SCell having the index value of ‘2’ is configured. In this instance, the UE may disregard a field associated with an SCell which is not configured for the UE. ‘R’ is a reserved bit, and is always set to ‘0’.

Situation 2: when a BS configures at least one PUCCH SCell for a UE, or when the BS receives, from a UE, an RRC message associated with a PCG and a PSCG.

In this instance, the BS may arbitrarily set a serving cell index (SCell index) of a PUCCH SCell(s) to a value in the range of C₁ to C₃₁. In this instance, the BS may use an LCID associated with the activation/deactivation MAC CE of 8 bits as it is, out of LCID values listed in Table 2, or may use a new LCID value for the extended activation/deactivation MAC CE.

Situation 3: when a BS informs a UE that an extended activation/deactivation MAC CE is to be transmitted through a separate RRC message.

The separate RRC message may be defined as enable-information associated with the extended activation/deactivation MAC CE. The enable-information associated with the extended activation/deactivation MAC CE may be included in an RRC reconfiguration message of Table 3 as provided below, or may be included in MAC-MainConfig that includes main configuration information associated with a MAC of Table 4 as provided below. In this instance, to distinguish the activation/deactivation MAC CE of 8 bits and the activation/deactivation MAC CE of 32 bits, a new LCID for the extended activation/deactivation MAC CE out of the LCID values listed in Table 2 may be assigned to the activation/deactivation MAC CE of 8 bits.

TABLE 3

| | |
|---|---|
| RF-Parameters ::= | SEQUENCE { |

...

| | | |
|---|---|---|
| supportedBandCombination | SupportedBandCombination | OPTIONAL |

}
SupportedBandCombination ::= SEQUENCE (SIZE (1..maxBandComb)) OF BandCombinationParameters

| | |
|---|---|
| BandCombinationParameters ::= | SEQUENCE { |

| | |
|---|---|
| bandParameterList | SEQUENCE (SIZE (1..maxSimultaneousBands)) OF |

BandParameters,

| supportedBandwidthCombinationSet | SupportedBandwidthCombinationSet OPTIONAL, |
|---|---|
| multipleTimingAdvance | ENUMERATED {supported} |
| OPTIONAL, | |
| simultaneousRx-Tx | ENUMERATED {supported} |

| OPTIONAL, | |
|---|---|
| bandInfoEUTRA | BandInfoEUTRA, |

...

}
BandParameters ::= SEQUENCE {

| | |
|---|---|
| bandEUTRA | FreqBandIndicator, |

| bandParametersUL | BandParametersUL |
|---|---|
| OPTIONAL, | |
| bandParametersDL | BandParametersDL |

OPTIONAL,

}
BandParametersUL ::= SEQUENCE (SIZE (1..maxBandwidthClass)) OF CA-MIMO-ParametersUL
CA-MIMO-ParametersUL ::= SEQUENCE {

| | |
|---|---|
| ca-BandwidthClassUL | CA-BandwidthClass, |
| supportedMIMO-CapabilityUL | MIMO-CapabilityUL |

OPTIONAL

}
BandParametersDL ::= SEQUENCE (SIZE (1..maxBandwidthClass)) OF CA-MIMO-ParametersDL
CA-MIMO-ParametersDL ::= SEQUENCE {

| | |
|---|---|
| ca-BandwidthClassDL | CA-BandwidthClass, |
| supportedMIMO-CapabilityDL | MIMO-CapabilityDL |

OPTIONAL

}
CA-BandwidthClass ::= ENUMERATED {a, b, c, d, e, f, ...}

TABLE 4

| MAC-MainConfig ::= | | SEQUENCE { |
|---|---|---|
| | ... | |
| | [[mac-MainConfig-v13xx | SEQUENCE { |

...

| | | | |
|---|---|---|---|
| extendedAD | ENUMERATED {setup} | OPTIONAL | -- |

Need OR

| | | |
|---|---|---|
| } | OPTIONAL | -- |

Need ON

]],

Here, the terminologies included in Table 3 and Table 4 will be described through Table 5 as provided below.

TABLE 5

| Abbreviation | Meaning |
|---|---|
| Need ON | Optionally present, No action |
| (Used in | An information element that is optional to signal. If the |
| downlink | message is received by the UE, and in case the information |
| only) | element is absent, the UE takes no action and where |
| | applicable shall continue to use the existing value (and/or |
| | the associated functionality). |
| Need OR | Optionally present, Release |
| (Used in | An information element that is optional to signal. If the |
| downlink | message is received by the UE, and in case the information |
| only) | element is absent, the UE shall discontinue/stop using/ |
| | delete any existing value (and/or the associated function- |
| | ality). |

When 9 or more serving cells are configured through an RRC reconfiguration procedure, when at least one PUCCH SCell is configured, or when information indicating that the extended activation/deactivation MAC CE is to be transmitted is received, the UE may recognize that the activation/deactivation MAC CE of FIG. 3A is received, and subsequently, when a message (MAC PDU) including an activation/deactivation MAC CE is received from the BS, the UE may activate or deactivate all of the serving cells configured for the UE based on an activation/deactivation indicator included in the corresponding message. However, when 8 or fewer serving cells are configured through the RRC reconfiguration procedure, when a PUCCH SCell is not configured, or when information indicating that the extended activation/deactivation MAC CE is to be transmitted is not received, the UE that receives a message including an activation/deactivation MAC CE from the BS, may recognize that the corresponding activation/deactivation MAC CE is in the format of FIG. 3B, and may activate or deactivate all of the serving cells configured for the UE based on an activation/deactivation indicator included in the corresponding message.

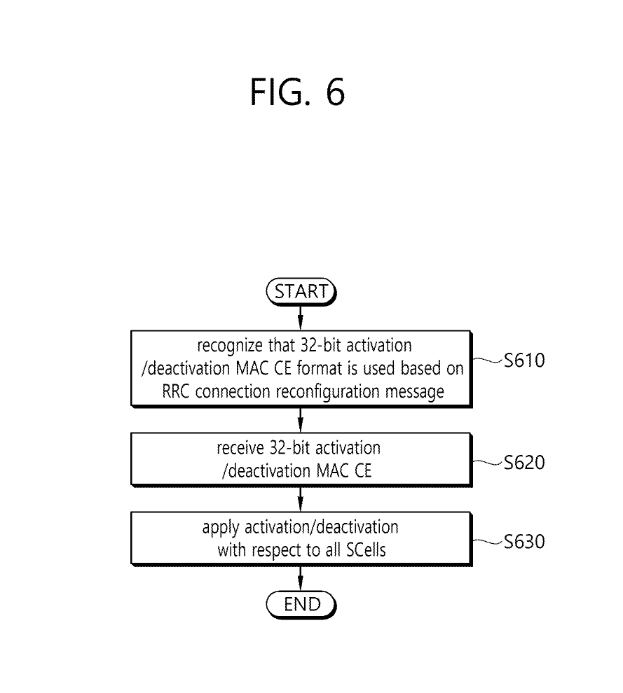

FIG. 6 is a flowchart illustrating the operations of a UE according to an embodiment of the present invention.

Referring to FIG. 6, the UE may configure 6 service cells, or 9 or more serving cells, through an RRC reconfiguration message. According to an exemplary embodiment, when at least one PUCCH SCell is configured, or when information indicating that an extended activation/deactivation MAC CE is to be transmitted is received, the UE recognizes that the extended activation/deactivation MAC CE of 32 bits, as illustrated in FIG. 3A, is used and received, in operation S610.

Here, when the UE is requested, by the BS through a UE capability information transfer procedure, to transmit UE capability information, the UE may configure the UE capability information, and may transmit the same to the BS. Here, the UE capability information may include information associated with frequency bands that the UE may support, information associated with CA-enable frequency band combinations, information associated with a bandwidth supportable in each frequency band, and the like. Also, the UE capability information may include information indicating that a maximum of 32 serving cells may be configurable for the corresponding UE. The procedure may be generated only when the BS does not retain the capability information associated with a corresponding UE, and the BS is incapable of determining the capability information of the corresponding UE through a Mobility Management Entity (MME).

Therefore, the BS may transmit, to the UE, an RRC reconfiguration message to configure 6 serving cells or 9 or more serving cells, based on the capability information of the UE. Also, the RRC reconfiguration message may include information associated with a cell group (mapping information between a PCell (or a PUCCH SCell) and an SCell(s)).

The UE receives an activation/deactivation MAC CE from the BS in operation S620. The UE determines whether the corresponding activation/deactivation MAC CE is an extended activation/deactivation MAC CE, and applies activation/deactivation to all of the serving cells configured for the UE, based on an indicator included in the corresponding activation/deactivation MAC CE, in operation S630.

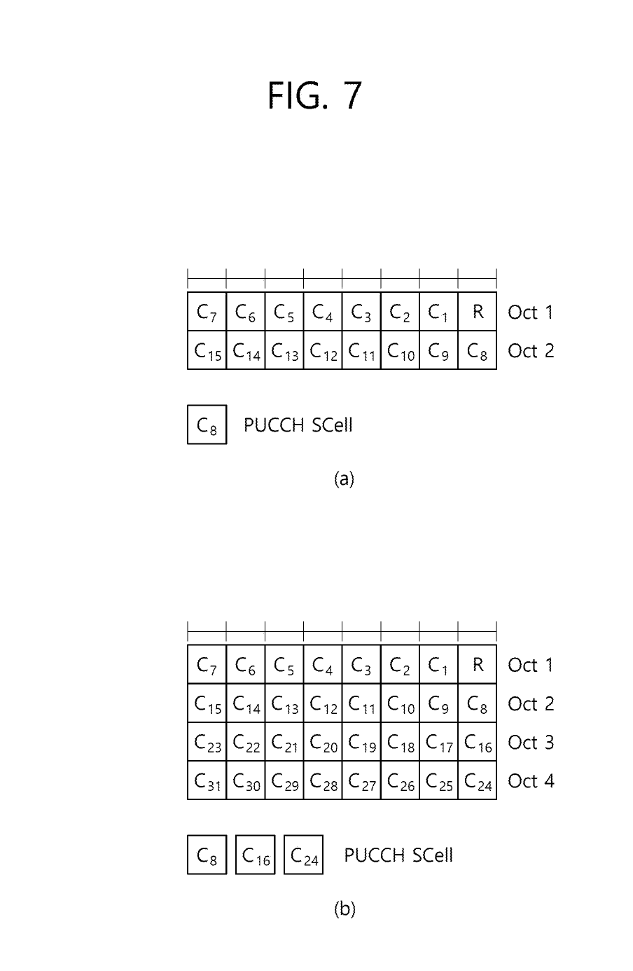

FIG. 7 is a diagram illustrating an activation/deactivation MAC CE according to another embodiment of the present invention.

According to a second embodiment of the present invention, when a PUCCH SCell that a BS configures for a UE is capable of being set to one of the fixed serving cell indices (SCell indices), such as C₈, C₁₆, C₂₄ and the like, the BS may transmit an activation/deactivation MAC CE having a length that varies based on the number of PUCH SCells configured for the UE, as illustrated in FIGS. 7A and 7B. In this instance, the situation where a maximum of 32 serving cells are configurable is as follows.

Situation 1: when a BS configures at least one PUCCH SCell for a UE.

In this instance, a maximum of 7 SCells may be mapped to a PCell and each PUCCH SCell. That is, at least one PCell or PUCCH SCell may be configured for each cell group, and a maximum of 7 SCells may be included in each cell group. FIG. 7A illustrates an example in which a single PUCCH SCell is configured for a UE, and FIG. 7B illustrates an example in which 3 PUCCH SCells are configured for a UE. Referring to FIGS. 7A and 7B, a PUCCH SCell index may be fixedly set to one of C₈, C₁₆, and C₂₄.

Situation 2: when a BS informs a UE that an activation/deactivation MAC CE of a new format, as shown in FIGS. 7A and 7B, is to be transmitted through a separate RRC message.

The separate RRC message may be defined as enable-information associated with an extended activation/deactivation MAC CE in an RRC reconfiguration message, as listed in above Table 4. When the BS transmits, to a UE, an RRC reconfiguration message including enable-information associated with the activation/deactivation MAC CE of the new format even though a PUCCH SCell is not configured for the UE, the BS configures a MAC subheader using an LCID (the LCID corresponding to ‘11001’ in Table 2) associated with the extended activation/deactivation MAC CE format. However, the format of the configured activation/deactivation MAC CE may be an activation/deactivation MAC CE having a length of 8 bits as illustrated in FIG. 3B, or an activation/deactivation MAC CE having a length of 16 to 32 bits, based on the total number of SCells configured for the UE.

For example, when the total number of SCells is 8 to 15, the activation/deactivation MAC CE has a length of 16 bits. When the total number of SCells is 16 to 23, the activation/deactivation MAC CE may have a length of 24 bits. When the total number of SCells is 24 to 31, the activation/deactivation MAC CE may have a length of 32 bits. To this end, the BS may change, in advance, an index of each SCell through the RRC connection reconfiguration procedure.

Alternatively, the format of the configured activation/deactivation MAC CE may be an activation/deactivation MAC CE having a length of 8 bits as illustrated in FIG. 3B, or may be an activation/deactivation MAC CE having a length of 16 to 32 bits, based on a value of the maximum serving cell index (SCell index) out of indices of the SCells configured for the UE.

For example, when the maximum serving cell index (SCell index) value is a value in the range of 8 to 15, the activation/deactivation MAC CE may have a length of 16 bits. When the maximum serving cell index (SCell index) value is a value in the range of 16 to 23, the activation/deactivation MAC CE may have a length of 24. When the maximum serving cell index (SCell index) value is a value in the range of 24 to 31, the activation/deactivation MAC CE may have a length of 32.

According to the second embodiment of the present invention, the length of the activation/deactivation MAC CE provided in the new format is determined based on the number of PUCCH SCells or the total number of SCells configured for the UE. Accordingly, with respect to the activation/deactivation MAC CE of the new format, a subheader having a length of 8 bits, which does not include an F/L field, may be used, as illustrated in FIG. 5C.

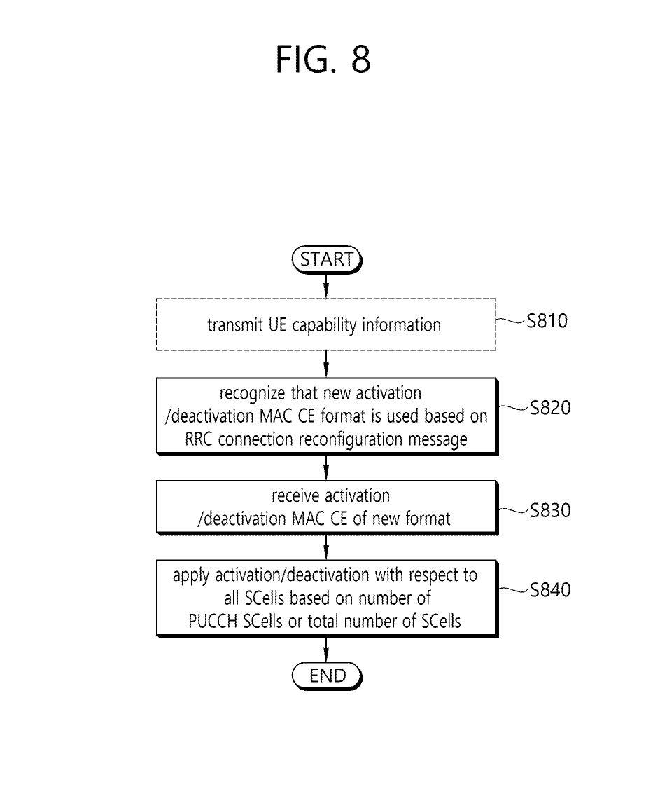

FIG. 8 is a flowchart illustrating the operations of a UE according to the embodiment of FIG. 7.

Referring to FIG. 8, when at least one PUCCH SCell is configured through an RRC reconfiguration message, or when information indicating that an extended activation/deactivation MAC CE is transmitted, is received, a UE recognizes that an activation/deactivation MAC CE of a new format, as illustrated in FIGS. 7A and 7B, is received in operation S820.

Here, when the UE is requested, by a BS through a UE capability information transfer procedure, to transmit UE capability information, the UE configures the UE capability information, and transmits the same to the BS in operation S810. Here, the UE capability information may include information associated with frequency bands that the UE may support, information associated with CA-enable frequency band combinations, information associated with a bandwidth supportable in each frequency band, and the like. Also, the UE capability information may include information indicating that a maximum of 6 (or 9) to 32 serving cells may be configured for the corresponding UE. Also, the RRC reconfiguration message may include information associated with a cell group (mapping information between a PCell (or a PUCCH SCell) and an SCell(s), or cell group information).

The UE receives, from the BS, an activation/deactivation MAC CE provided in a new format (in association with a configuration of a maximum of 6 (or 9) to 32 serving cells), in operation S830. Activation/deactivation may be applied with respect to all of the serving cells configured for the UE, based on the number of PUCCH SCells or the total number of SCells configured for the UE, in operation S840.

According to the first embodiment and the second embodiment of the present invention, when the UE receives an RRC reconfiguration message that does not include Mobility Control Information (MCI), or when an SCell that is added or modified through the RRC reconfiguration message is a PUCCH SCell, the initial state thereof is a ‘deactivated’ state. The activation/deactivation state of an SCell, which is reconfigured through the RRC reconfiguration message or that is not changed, may not be changed. That is, the state may be maintained. When the UE receives an RRC reconfiguration message that includes the MCI, that is, in the case of handover, all the SCells including a PUCCH SCell are changed to the ‘deactivation’ state. In addition, the SRS resource and the PUCCH resources of the PUCCH SCell are no longer available in a BS where the UE is handed over, and thus, the UE may release the PUCCH resources and the SRS resource.

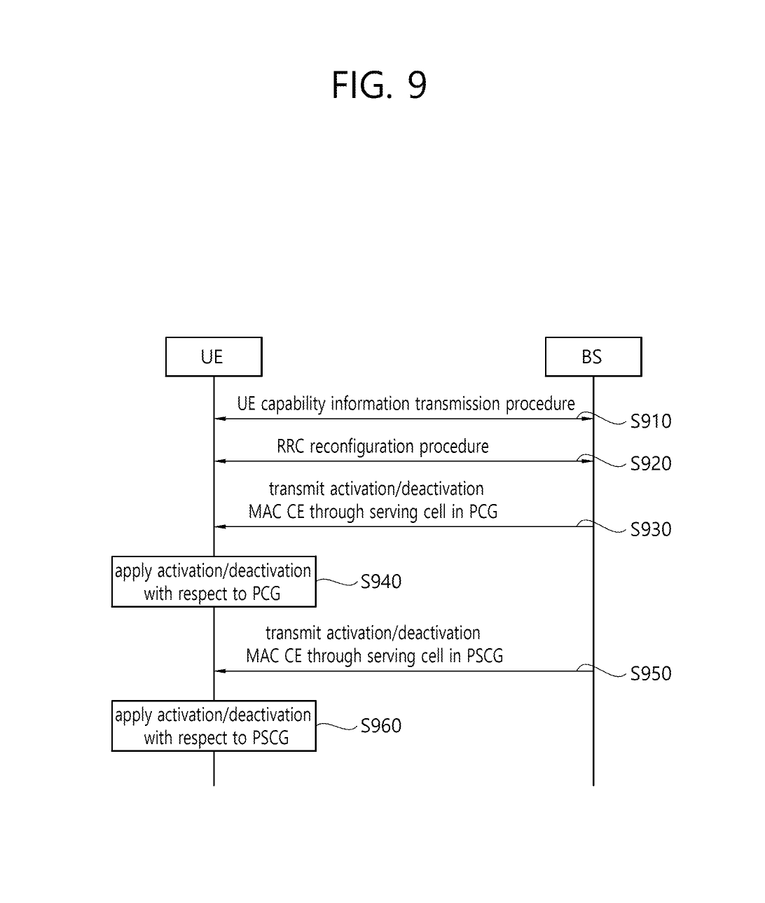

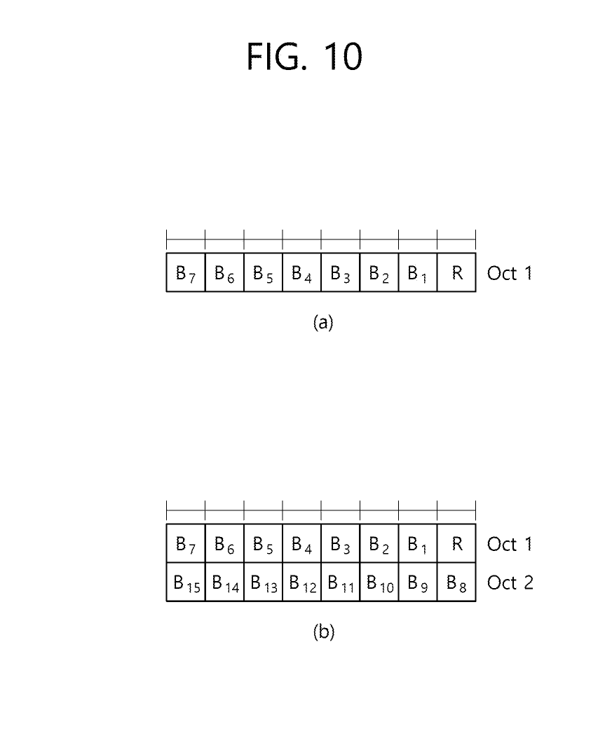

FIG. 9 is a diagram illustrating a method of indicating activation/deactivation of serving cells according to another embodiment of the present invention. FIG. 10 is a diagram illustrating an activation/deactivation MAC CE according to the embodiment of FIG. 9.

According to a third embodiment, when it is the situation where a maximum of 6 (or 9) to 32 serving cells are capable of being configured for a single UE, a BS may configure an activation/deactivation MAC CE of a new format with respect to a single cell group having a variable length, and transmit the same to the UE. That is, the length (the number of bits) of the activation/deactivation MAC CE of the new format with respect to the single cell group may change based on the number of serving cells included in the cell group.

For example, referring to FIG. 9, when it is difficult to secure the information associated with a predetermined UE (when the information associated with the corresponding UE is not stored in a BS and the information associated with the corresponding UE is not also stored in a Mobility Management Entity (MME)), the BS may request, from the UE through a UE capability transfer procedure, UE capability information including information associated with a frequency band that may be supported by the corresponding UE, in operation S910.

The UE may transmit, to the BS through a UE capability information transmission procedure, UE capability information including information associated with a frequency band that may be supported by the UE, information associated with CA-enable frequency bands combinations (band combination), information associated with a bandwidth that may be supportable in each frequency band (bandwidth combination set), and the like. Here, the information associated with the CA-enable frequency band combinations may include the number of component carriers that may be configurable in each frequency band included in the CA-enable frequency band combination, and information associated with whether CA of component carriers in non-contiguous frequency bands is possible. The information may be separated into information associated with an uplink and information associated with a downlink.

The BS may determine whether a maximum of 6 (or 9) to 32 serving cells are capable of being configured for the corresponding UE, based on the UE capability information. When it is determined that a maximum of 6 (or 9) to 32 serving cells are configurable for the UE, the BS informs the UE that an activation/deactivation MAC CE of a new format with respect to the single cell group is transmitted, by using a separate RRC message through an RRC reconfiguration procedure, in operation S920.

In this instance, when the UE receives the activation/deactivation MAC CE through a serving cell in a PCG in operation S930, the UE recognizes that an indicator included in the corresponding activation/deactivation MAC CE is an activation/deactivation indicator with respect to the serving cells in the PCG, and applies activation/deactivation with respect to the serving cells in the PCG in operation S940. When the activation/deactivation MAC CE is received through a serving cell in a PSCG in operation S950, the UE recognizes that an indicator included in the corresponding activation/deactivation MAC CE is an activation/deactivation indicator with respect to the serving cells in the PSCG, and applies activation/deactivation with respect to the serving cells in the PSCG in operation S960.

That is, when an activation/deactivation MAC CE of a new format with respect to a single cell group, as illustrated in FIGS. 10A and 10B, is received, the UE may recognize a cell group which an indicator included in the corresponding activation/deactivation MAC CE is associated with, based on a serving cell through which the corresponding activation/deactivation MAC CE is received.

The activation/deactivation MAC CE of the new format with respect to a single cell group, as illustrated in FIGS. 10A and 10B, may be used when the BS informs the UE that the activation/deactivation MAC CE of the new format with respect to the single cell group is to be transmitted, through a separate RRC message that is based on an extended activation/deactivation field as listed in Table 4 and a new LCID (an LCID associated with the extended activation/deactivation MAC CE) out of the LCIDs listed in Table 2.

The length of the activation/deactivation MAC CE of the new format with respect to the single cell group may change based on the number of serving cells included in the cell group, and a serving cell index (SCell index) associated with the position of a bit that indicates activation/deactivation may be a serving cell index in a cell group. To this end, a serving cell index (SCell index) configured for each UE may exist, and in addition, a serving cell index may be assigned to each serving cell in a group.

For example, when it is assumed that the number of serving cells included in a PCG is 7 and the number of serving cells included in a PSCG is 14, the BS may configure serving cell indices within a group in the range of B₁ to B₇, for the SCells in the PCG, and may configure serving cell indices within a group in the range of B₁ to B₁₅, for the SCells in the PSCG. The BS may transmit, to the serving cells in the PCG, the activation/deactivation MAC CE as illustrated in FIG. 10A, and may transmit, to the serving cells in the PSCG, the activation/deactivation MAC CE as illustrated in the FIG. 10B. When the activation/deactivation MAC CE of FIG. 10A is transmitted, a subheader having a length of 8 bits which does not include an F/L field, as illustrated in FIG. 5C, may be used as a subheader of the corresponding activation/deactivation MAC CE. When the activation/deactivation MAC CE of FIG. 10B is transmitted, a subheader that includes an F/L field, as illustrated in FIG. 5A or 5B may be used as a subheader of the corresponding activation/deactivation MAC CE.

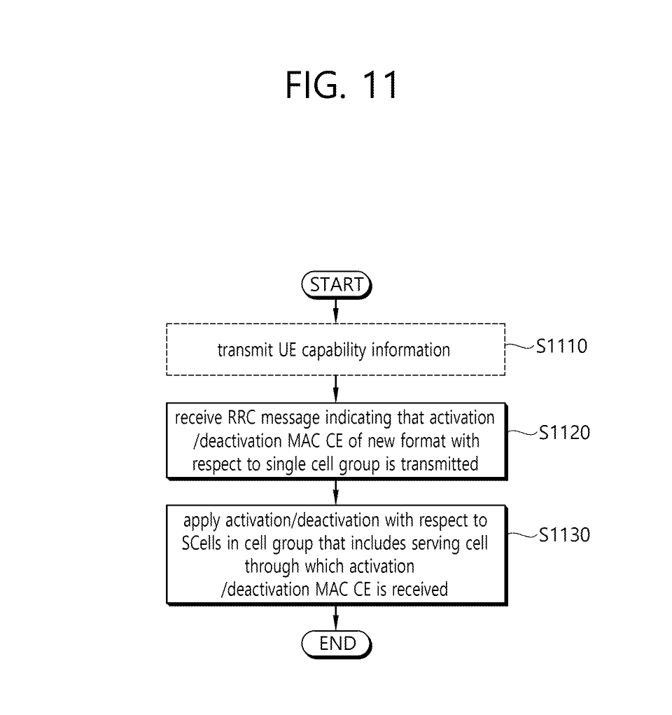

FIG. 11 is a flowchart illustrating the operations of a UE according to the embodiment of FIG. 10.

Referring to FIG. 11, a UE receives, from a BS through an RRC connection reconfiguration procedure, an RRC message indicating that an activation/deactivation MAC CE of a new format with respect to a single cell group is transmitted, in operation S1120. Here, the UE recognizes that the activation/deactivation MAC CE of the new format with respect to the single cell group, as illustrated in FIG. 10A and FIG. 10B.

Here, according to the third embodiment, when the UE is requested, by the BS through a UE capability information transfer procedure, to transmit UE capability information, the UE configures the UE capability information, and transmits the same to the BS in operation S1110. Here, the UE capability information may include information associated with frequency bands that the UE may support, information associated with CA-enable frequency band combinations, information associated with a bandwidth supportable in each frequency band, and the like. Also, the UE capability information may include information indicating that a maximum of 6 (or 9) to 32 serving cells may be configured for the corresponding UE. Also, the RRC message may include information associated with a cell group (mapping information between a PCell (or a PUCCH SCell) and an SCell(s), or cell group information).

Subsequently, when the activation/deactivation MAC CE of the new format with respect to the single cell group is received, the UE applies activation/deactivation to serving cells in the cell group that includes a serving cell through which the corresponding activation/deactivation MAC CE is received, based on a serving cell index and a serving cell index within the cell group, in operation S1130. When all of the SCells configured for the UE have a mapping relationship with the PCell, that is, when only a single cell group is configured for a UE, a serving cell index (one of C₁ to C₃₁) assigned to a serving cell (SCell) and a serving cell index (one of B₁ to B₃₁) within the cell group may be identical to each other.

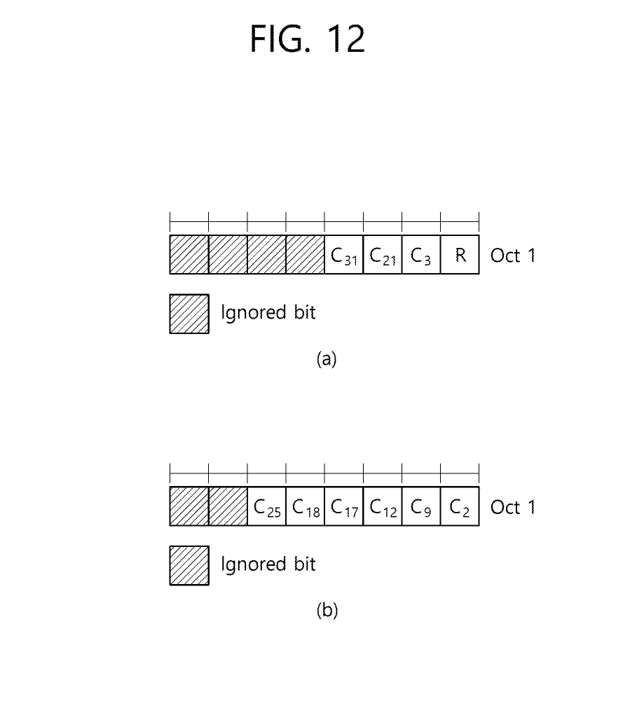

FIG. 12 is a diagram illustrating an activation/deactivation MAC CE according to another embodiment of the present invention.

According to a fourth embodiment, when it is the situation where a maximum of 6 (or 9) to 32 serving cells are capable of being configured for a single UE, a BS may configure an activation/deactivation MAC CE based on a PCG and a PSCG. In this instance, the UE may determine the range to which a corresponding activation/deactivation MAC CE is applied, based on a serving cell through which the activation/deactivation MAC CE is received. In this instance, an activation/deactivation MAC CE that may be used may be an activation/deactivation MAC CE of 8 bits. The activation/deactivation MAC CE may use an LCID associated with the activation/deactivation MAC CE of 8 bits as it is, and may use an LCID for an activation/deactivation MAC CE of a new format (an LCID for an extended activation/deactivation MAC CE as listed in Table 2) as needed. Therefore, setting an RRC for the same may not be required. In this instance, with respect to the activation/deactivation MAC CE, a subheader having a length of 8 bits that does not include an F/L field may be used as illustrated in FIG. 5C.

For example, when it is assumed that serving cell indices (SCell indices) of SCells included in a PCG, which includes a PCell and 3 SCells, are #3, #21, and #31, respectively, and serving cell indices (SCell indices) of SCells included in a PSCG, which includes a PUSCH SCell and 6 SCells, are #2, #9, #12, #17, #18, and #25, respectively, an activation/deactivation MAC CE that is received through a serving cell (the PCell) in the PCG may be understood as illustrated in FIG. 12A, and an activation/deactivation MAC CE that is received through a serving cell (the PUCCH SCell) in the PSCF may be understood as illustrated in FIG. 12B. In this instance, in the activation/deactivation MAC CE, an indicator with respect to the PUCCH SCell may be located in a bit corresponding to the PCell. That is, in FIG. 12B, the index of the PUCCH SCell may be #2.

The reason of changing the mapping relationship of a serving cell index (SCell index) based on the position of a bit of the activation/deactivation MAC CE, is as follows. To change a serving cell index (SCell index), a procedure that removes an SCell and adds an SCell again is required. When a serving cell index (SCell) is changed while a mapping relationship between a PCell (or a PUCCH Scell) and SCells is configured again through an RRC reconfiguration procedure, a series of operations, such as Hybrid Automatic Repeat Request (HARQ) retransmission and the like, which need to be continuously executed may be affected.

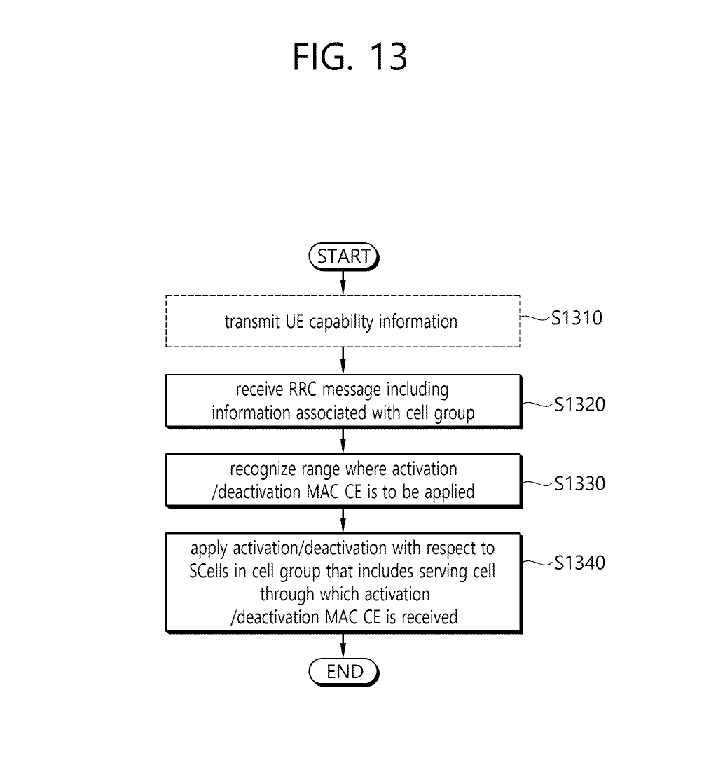

FIG. 13 is a flowchart illustrating the operations of a UE according to the embodiment of FIG. 12.

Referring to FIG. 13, a UE receives, from a BS through an RRC connection reconfiguration procedure, an RRC message including information associated with a cell group (information associated with mapping between a PCell (or a PUCCH SCell) and SCells) in operation S1320. The UE recognizes the range to which an activation/deactivation MAC CE received from the BS is applied, based on the information associated with the cell group, in operation S1330.

Here, according to the fourth embodiment, when the UE is requested, by the BS through a UE capability information transfer procedure, to transmit UE capability information, the UE configures the UE capability information, and transmits the same to the BS in operation S1310. Here, the UE capability information may include information associated with frequency bands that the UE may support, information associated with CA-enable frequency band combinations, information associated with a bandwidth supportable in each frequency band, and the like. Also, the UE capability information may include information indicating that a maximum of 6 (or 9) to 32 serving cells may be configured for the corresponding UE.

Subsequently, when an activation/deactivation MAC CE is received, the UE applies activation/deactivation to serving cells in a cell group that includes a serving cell through which the corresponding activation/deactivation MAC CE is received in operation S1340. In this instance, a PCG and a PSCG may include a PCell or at least one PUCCH SCell, and may include a maximum of 7 SCells.

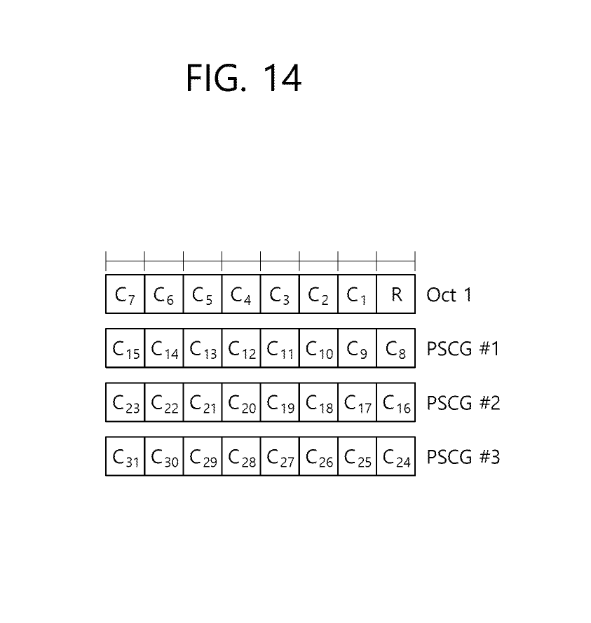

FIG. 14 is a diagram illustrating an activation/deactivation MAC CE according to another embodiment of the present invention.

According to a fifth embodiment, when it is the situation where a maximum of 6 (or 9) to 32 serving cells are capable of being configured for a single UE, like the fourth embodiment, a BS may configure an activation/deactivation MAC CE of 8 bits based on a PCG and a PSCG. In the same manner as the fourth embodiment, the activation/deactivation MAC CE may use an LCID associated with the activation/deactivation MAC CE of 8 bits as it is, and may use an LCID for an activation/deactivation MAC CE of a new format (an LCID for an extended activation/deactivation MAC CE as listed in Table 2) as needed. In this instance, the UE may determine the range where the corresponding activation/deactivation MAC CE is applied, based on a serving cell through which the activation/deactivation MAC CE is received, in the same manner of the fourth embodiment. However, unlike the fourth embodiment, the mapping relationship of a serving cell index (SCell index) based on the position of a bit of the activation/deactivation MAC CE may be fixed. In this instance, with respect to the activation/deactivation MAC CE, a subheader having a length of 8 bits that does not include an F/L field may be used as illustrated in FIG. 5C.

For example, as illustrated in FIG. 14, a serving cell index (SCell index) of each SCell that is included in a PCG may be fixed to one of #1 to #7. A serving cell index (SCell index) of each SCell that is included in a first PSCG may be fixed to one of #8 to #15. A serving cell index (SCell index) of each SCell that is included in a second PSCG may be fixed to one of #16 to #23. A serving cell index (SCell index) of each SCell that is included in a third PSCG may be fixed to one of #24 to #31. In this instance, a serving cell index (SCell index) of a PUCCH SCell may be one of the serving cell indices (SCell indices) of a corresponding PSCG.

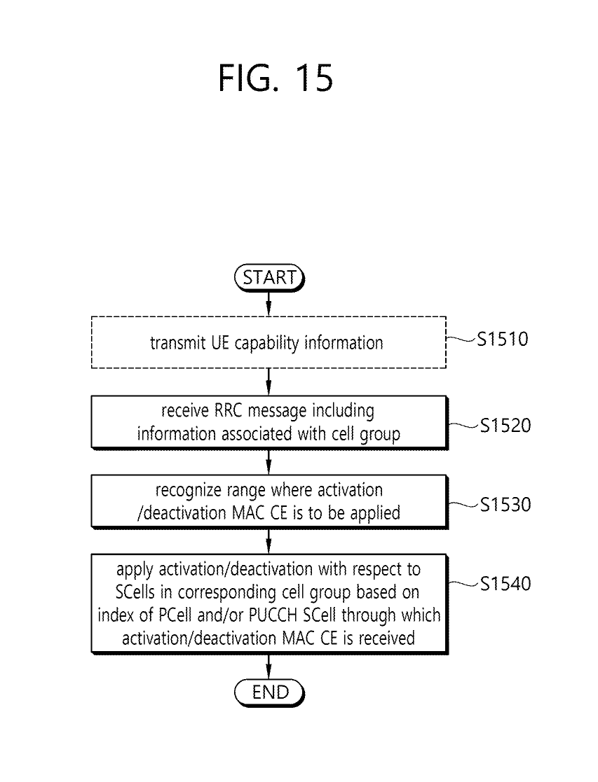

FIG. 15 is a flowchart illustrating the operations of a UE according to the embodiment of FIG. 14.

According to the fifth embodiment, a UE receives, from a BS through an RRC connection reconfiguration procedure, an RRC message including information associated with a cell group (information associated with mapping between a PCell (or a PUCCH SCell) and SCells) in operation S1520. Here, when the UE is requested, by the BS through a UE capability information transfer procedure, to transmit UE capability information, the UE may configure the UE capability information, and may transmit the same to the BS in operation S1510. Here, the UE capability information may include information associated with frequency bands that the UE may support, information associated with CA-enable frequency band combinations, information associated with a bandwidth supportable in each frequency band, and the like. Also, the UE capability information may include information indicating that a maximum of 6 (or 9) to 32 serving cells may be configured for the corresponding UE.

The UE recognizes the range to which an activation/deactivation MAC CE received from the BS is applied, based on the information associated with the cell group, in operation S1530. Subsequently, when an activation/deactivation MAC CE is received, the UE applies activation/deactivation to serving cells in the corresponding cell group based on an index of a PCell cell and/or PUCCH SCell through which the corresponding activation/deactivation MAC CE is received, in operation S1540. In this instance, a PCG and a PSCG may include a PCell or at least one PUCCH Scell, and may include a maximum of 7 SCells.

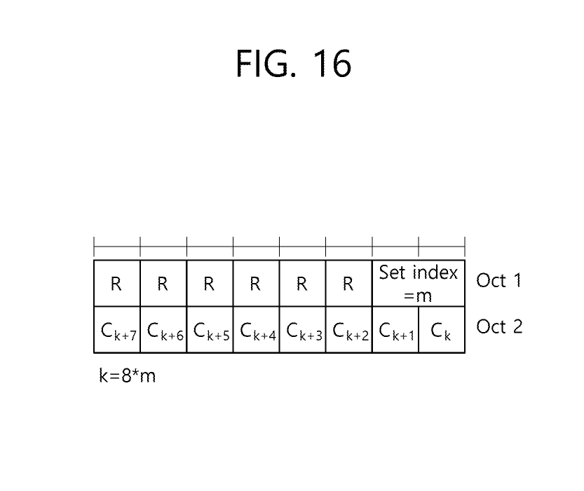

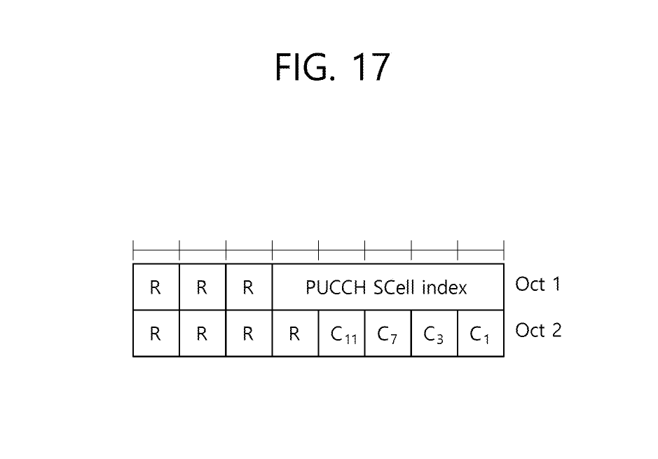

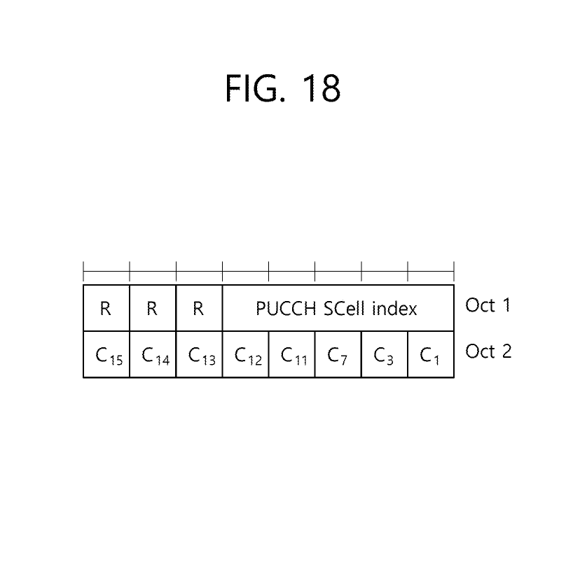

FIG. 16 is a diagram illustrating an activation/deactivation MAC CE according to another embodiment of the present invention.

According to a sixth embodiment, when it is the situation where a maximum of 6 (or 9) to 32 serving cells are capable of being configured for a single UE, like the fourth embodiment, a BS may configure an activation/deactivation MAC CE having a fixed length of 16 bits, based on a PCG and a PSCG. In this instance, an LCID for an activation/deactivation MAC CE of a new format (an LCID for an extended activation/deactivation MAC CE as listed in Table 2) may be used. The UE may determine the range where the corresponding activation/deactivation MAC CE is applied, based on a serving cell set indicated by a serving cell set index in the activation/deactivation MAC CE, and the mapping relationship of a serving cell index (SCell index) based on the position of a bit associated with the activation/deactivation MAC CE may be fixed. In this instance, with respect to the activation/deactivation MAC CE, a subheader having a length of 8 bits that does not include an F/L field may be used as illustrated in FIG. 5C. Here, the serving cell set may be configured to be fixed. Serving cell set #0 may include serving cell indices 0 to 7. Serving cell set #1 may include serving cell indices 8 to 15. Serving cell set #2 may include serving cell indices 16 to 23. Serving cell set #3 may include serving cell indices 24 to 31.

For example, as illustrated in FIG. 16, serving cell indices (SCell indices) of SCells included in each serving cell set may be determined based on each serving cell set as described above, and the serving cell indices (SCell indices) may be mapped in an ascending order from the farthest right bit to the left. In this instance, a serving cell index (SCell index) of a PUCCH SCell may be one of the serving cell indices (SCell indices) in a corresponding serving cell set, or the PUCCH SCell may not exist. The serving cell set used in the present embodiment may indicate the concept that is identical to a cell group that is fixedly defined based on a serving cell index, as described above. Alternatively, the serving cell set index may be defined as a parameter that indicates the range of a serving cell index (SCell index) indicated by an activation/deactivation MAC CE, as opposed to the form of a serving cell set that is actually configured for a UE. That is, m=0 of FIG. 16 may indicate serving cell indices 0 to 7. m=1 may indicate serving cell indices 8 to 15. m=2 may indicate serving cell indices 16 to 23. m=3 may indicate serving cell indices 24 to 31.

FIG. 17 and FIG. 18 are diagrams illustrating an activation/deactivation MAC CE according to another embodiment of the present invention.

According to a seventh embodiment, when it is the situation where a maximum of 6 (or 9) to 32 serving cells are capable of being configured for a single UE, like the fourth embodiment, a BS may configure an activation/deactivation MAC CE having a variable length, based on a PCG and a PSCG. In this instance, an LCID for an activation/deactivation MAC CE of a new format (an LCID for an extended activation/deactivation MAC CE as listed in Table 2) may be used. The UE may determine the range where the corresponding activation/deactivation MAC CE is applied, based on a PCG or a PSCG indicated by a PUCCH SCell index or a PCell index in the activation/deactivation MAC CE, and the mapping relationship of a serving cell index (SCell index) based on the location of a bit of the activation/deactivation MAC CE may be changeable. In this instance, with respect to the activation/deactivation MAC CE, a subheader having a length of 8 bits that does not include an F/L field may be used as illustrated in FIG. 5C.

For example, as illustrated in FIG. 17, serving cell indices (SCell index) of SCells included in a PCG are formed of indices of serving cells included in the PCG out of #0 to #31, and the serving cell indices (SCell indices) may be mapped in ascending order from the farthest right bit to the left. In this instance, a serving cell index (SCell index) of a PUCCH SCell may be one of the serving cell indices (SCell indices) of each PSCG. When the number of serving cells in the PCG or PSCG is fewer than 8, a bit to which a serving cell index (SCell index) is not mapped may exist and the bit may be disregarded by the UE, as illustrated in FIG. 17. As an example, FIG. 17 shows a PSCG that is formed of a total of 4 SCells having serving cell indices (SCell indices)={1, 3, 7, 11}.

Alternatively, as illustrated in FIG. 18, the serving cell indices (SCell indices) may be mapped in ascending order within the range in which a serving cell index (SCell index) does not exceed #31 in terms of the maximum value of the serving cell indices (SCell indices) in the PSCG. When a serving cell index (SCell index) reaches #31 and a bit to which a serving cell index (SCell index) is not mapped remains, the bit may be disregarded by the UE.

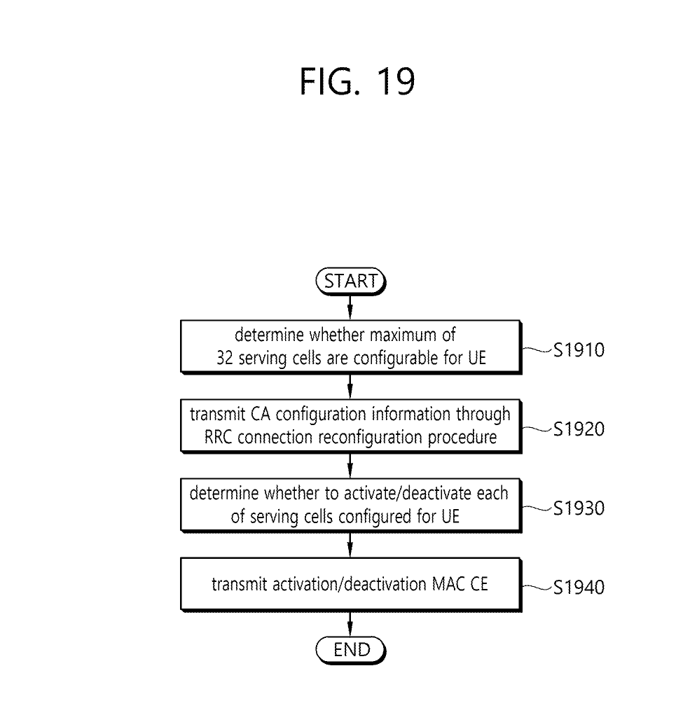

FIG. 19 is a flowchart illustrating the operations of a BS according to an embodiment of the present invention.

A BS determines whether a maximum of 9 (or 6) to 32 serving cells are capable of being configured for a single UE, so as to support CA of a maximum of 32 serving cells for the UE, in operation S1910. To this end, as an example, the BS may determine UE information stored in the BS, UE information stored in an MME, and the like. When the information associated with corresponding UE does not exist, the BS may request UE capability information from the UE through a capability information transfer procedure.

When it is determined that a maximum of 32 serving cells are configurable for the UE based on the UE capability information, the BS transmits CA configuration information to the UE through an RRC connection reconfiguration procedure in operation S1920. In this instance, the BS informs the UE that an activation/deactivation MAC CE of a new format as described above is to be transmitted, through an additional RRC message. Alternatively, by transmitting the information associated with a cell group, the BS may implicitly indicate that the BS is to transmit an activation/deactivation MAC CE of a new format to the corresponding UE. Subsequently, the BS determines whether to activate/deactivate each of the SCells configured for the corresponding UE in operation 1930, and configures an activation/deactivation MAC CE of a new format based on the determination, and transmits the same in the form of a MAC PDU in operation S1940.

According to the third embodiment, the fourth embodiment, and the fifth embodiment of the present invention, when the UE receives an RRC reconfiguration message that does not include Mobility Control Information (MCI), or when an SCell that is added or modified through the RRC reconfiguration message is a PUCCH SCell, the initial state thereof is an ‘activated’ state. That is, when the configuration of a PUCCH through an RRC reconfiguration message is completed, the PUCCH SCell may be activated. When the PUCCH SCell is deactivated by the BS, the UE may release all of the PUCCH resources of the PUCCH SCell, or may release only the resources used for transmitting ACK/NACK information with respect to downlink data. The activation/deactivation state of an SCell, which is reconfigured through the RRC reconfiguration message or is not changed, may not be changed. That is, the state may be maintained. When the UE receives an RRC reconfiguration message that includes the MCI, that is, in the case of handover, all the SCells including a PUCCH SCell are changed into the ‘deactivated’ state. In addition, the SRS resource and the PUCCH resources of the PUCCH SCell are no longer available in a BS to which the UE is handed over, and thus, the UE may release the PUCCH resources and the SRS resource.

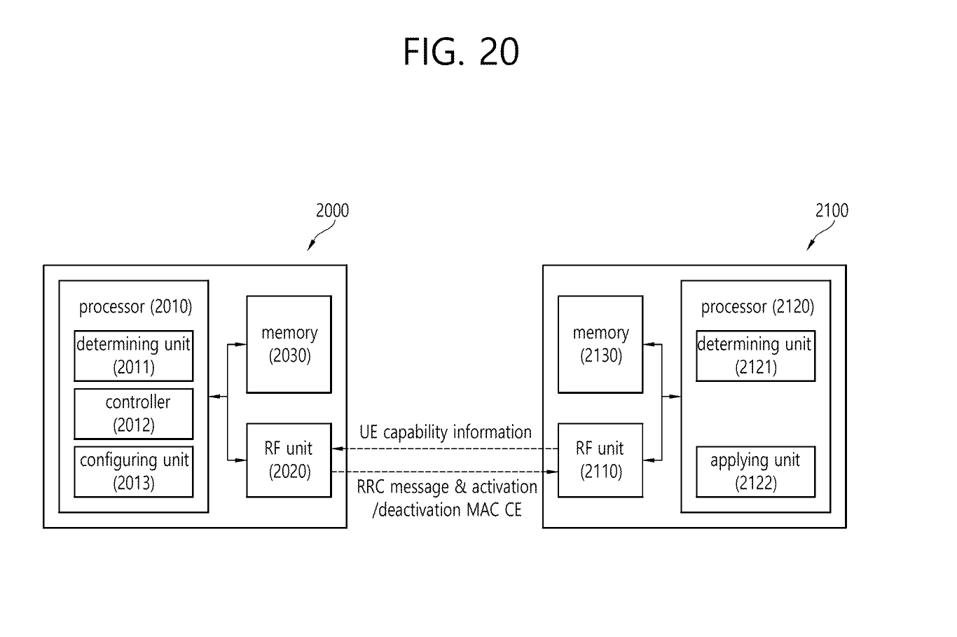

FIG. 20 is a block diagram illustrating a wireless communication system according to an embodiment of the present invention.

Referring to FIG. 20, a wireless communication system that supports communication between UEs may include a BS 2000 and a UE 2100.

The BS 2000 includes a processor 2010, a Radio Frequency (RF) unit 2020, and a memory 2030. The memory 2030 is connected to the processor 2010, and stores various pieces of information for driving the processor 2010. The RF unit 200 is connected with the processor 2010, and transmits and/or receives a wireless signal. For example, the RF unit 2020 may receive, from the UE 2100, an uplink signal including UE capability information disclosed in the present specifications. Also, the RF unit 2020 may transmit, to the UE 2100, an RRC message, an activation/deactivation MAC CE message, and the like, disclosed in the present specification. The processor 2010 may implement functions, processes, and/or methods proposed in the present specifications. Particularly, the processor 2010 may implement the operations of the BS 2000 according to the first through seventh embodiments.

For example, the processor 2010 may include a determining unit 2011, a controller 2012, and a configuring unit 2013.

The determining unit 2011 may determine whether a maximum of 6 (or 9) to 32 serving cells are capable of being configured for the UE 2100, based on the UE capability information. Here, the UE capability information may include information associated with frequency bands that the UE may support, information associated with CA-enable frequency band combinations, information associated with a bandwidth supportable in each frequency band, and the like. Also, the UE capability information may include information indicating that a maximum of 6 (or 9) to 32 serving cells may be configured for the corresponding UE. Also, the determining unit 2011 may determine whether to activate/deactivate each of the serving cells configured for the UE 2100.

When the determining unit 2011 determines that a maximum of 6 (or 9) to 32 serving cells are configurable for the UE 2100, the controller 2012 may execute a control to configure an activation/deactivation MAC CE according to the first embodiment through seventh embodiment.

The configuring unit 2013 may configure an activation/deactivation MAC CE under the control of the controller 2012, and may configure a MAC PDU including the configured activation/deactivation MAC CE.

For example, according to the first embodiment of the present disclosure, when 9 or more serving cells are configured for the UE, when at least one PUCCH SCell is configured for the UE, or when information indicating that an activation/deactivation MAC CE of a new format is to be transmitted is reported to the UE through a separate RRC message, the controller 1712 may execute a control to configure an activation/deactivation MAC CE of 32 bits, as illustrated in FIG. 3A. For the rest, the controller 1712 may execute a control to configure an activation/deactivation MAC CE format of 8 bits, as illustrated in FIG. 3B.

According to the second embodiment of the present disclosure, when at least one PUCCH SCell is configured to the UE, or when information indicating that an activation/deactivation MAC CE of a new format is to be transmitted is reported to the UE through a separate RRC message, or the like, the controller 2012 may execute a control to configure an activation/deactivation MAC CE having a length that is variable based on the number of PUCCH SCells, as illustrated in FIGS. 7A, 7B, and the like. To this end, the controller 202 may change, in advance, an index of each SCell through an RRC connection reconfiguration procedure. Alternatively, the format of the configured activation/deactivation MAC CE may be an activation/deactivation MAC CE having a length of 8 bits as illustrated in FIG. 3B, or an activation/deactivation MAC CE having a length of 16 to 32 bits based on a value of the maximum serving cell index (SCell index) out of the indices of the SCells configured for the UE.

For example, when the maximum serving cell index (SCell index) value is a value in the range of 8 to 15, the activation/deactivation MAC CE may have a length of 16 bits. When the maximum serving cell index (SCell index) value is a value in the range of 16 to 23, the activation/deactivation MAC CE may have a length of 24. When the maximum serving cell index (SCell index) value is a value in the range of 24 to 31, the activation/deactivation MAC CE may have a length of 32.

According to the third embodiment of the present disclosure, when information indicating that an activation/deactivation MAC CE of a new format is to be transmitted is reported to the UE through a separate RRC message, the controller 2012 may execute a control to configure an activation/deactivation MAC CE for a single cell group, which has a variable length, as illustrated in FIGS. 10A, 10B, and the like.

According to the fourth embodiment of the present disclosure, the controller 2012 executes a control to configure an activation/deactivation MAC CE of 8 bits, as illustrated in FIGS. 12A, 12B, and the like, based on the information associated with a cell group, and may execute a control to transmit the configured activation/deactivation MAC CE through a corresponding PCell or PUCCH SCell.

According to the fifth embodiment of the present disclosure, the controller 2012 executes a control to configure an activation/deactivation MAC CE of 8 bits, as illustrated in FIGS. 14A, 14B, and the like, based on the information associated with a cell group, an index of a PCell (or PUCCH SCell) and the like, and may execute a control to transmit the configured activation/deactivation MAC CE through a corresponding PCell or PUCCH SCell.

According to the sixth embodiment of the present disclosure, the controller 2012 may execute a control to configure an activation/deactivation MAC CE having a fixed length of 16 bits as illustrated in FIG. 16 and the like, based on the information associated with a cell group. In this instance, an LCID for an activation/deactivation MAC CE of a new format (an LCID for an extended activation/deactivation MAC CE as listed in Table 2) may be used.

According to the seventh embodiment and/or the eighth embodiment of the present disclosure, the controller 2012 may execute a control to configure an activation/deactivation MAC CE having a variable length as illustrated in FIGS. 17, 18, and the like, based on the information associated with a cell group. In this instance, an LCID for an activation/deactivation MAC CE of a new format (an LCID for an extended activation/deactivation MAC CE as listed in Table 2) may be used.

The memory 2030 may store UE capability information and the like according to the present specification, and may provide the same to the processor 2010 by the request of the processor 2010.

The UE 2100 includes a Radio Frequency (RF) unit 2110, a processor 2120, and a memory 2130. The memory 2130 is connected to the processor 2120, and stores various pieces of information for driving the processor 2120. The RF unit 2110 is connected to the processor 2120, and transmits and/or receives a wireless signal. The processor 2120 may implement the functions, processes, and/or methods proposed in the present specifications. In the above described embodiments, the operations of the UE 2100 may be implemented by the processor 2120. The processor 2120 may generate UE capability information disclosed in the present specifications, and may apply activation/deactivation with respect to a corresponding SCell based on an activation/deactivation MAC CE received from the BS 2000.

For example, the processor 2120 may include a determining unit 2121 and an applying unit 2122.

Based on the information associated with a cell group and/or the information indicating that an activation/deactivation MAC CE of a new format is to be transmitted and the like, which is received from the BS 2000, the determining unit 2121 may determine the format of an activation/deactivation MAC CE to be received.

The applying unit 2121 may apply activation/deactivation with respect to corresponding SCells based on an activation/deactivation MAC CE that is received through the RF unit 2110 according to a result determined by the determining unit 2121.

According to one or more exemplary embodiments, a Base Station (BS) may transfer activation/deactivation information with respect to a maximum of 32 serving cells through a single Medium Access Control (MAC) control element message.

Also, a BS may recognize the situation where a maximum of 32 serving cells are configurable for a UE, and the UE may recognize that an activation/deactivation MAC control element message in a new format is transmitted.

According to an exemplary embodiment, a UE may receive, from a base station, a Radio Resource Control (RRC) message including cell configuration information for the UE, the cell configuration information for the UE including configuration information of a maximum of 32 serving cells. The UE may receive, from the base station, activation/deactivation Media Access Control (MAC) information associated with secondary serving cells configured for the UE, the activation/deactivation MAC information including a 4-octet MAC control element (CE) and a Logical Channel Identifier associated with the 4-octet MAC CE. At least part of the 4-octet MAC CE is associated with an activation or deactivation of the secondary serving cells configured for the UE. The UE controls activation/deactivation states of the secondary serving cells configured for the UE according to values of the at least part of the 4-octet MAC CE.

In a case where a serving cell index of at least one of the secondary serving cells configured for the UE is greater than seven, the cell configuration information for the UE indicates the serving cell index, which is greater than seven. In this case, an extended LCID and a 4-octet MAC CE are used for activation/deactivation states controlling. Each octet of the 4-octet MAC CE consists of eight bits, and the at least part of the 4-octet MAC CE is determined based on serving cell indexes of the secondary serving cells configured for the UE.

The UE may transmit, to the base station, UE capability information including at least one of information of frequency bands supportable by the UE, information of frequency bands available for carrier aggregation, and information associated with a bandwidth supportable in a frequency band. Further, the UE may transmit, to the base station, UE capability information including information indicating that the UE supports a maximum of 32 serving cells.

The UE may identify the Logical Channel Identifier associated with the 4-octet MAC CE from a MAC header of the activation/deactivation MAC information, and identify the 4-octet MAC CE based on a value of the Logical Channel Identifier. The 4-octet MAC CE includes one reserved field and 31 non-reserved fields, at least part of the 31 non-reserved fields being associated with the activation/deactivation states of the secondary serving cells configured for the UE.

The UE may receive a second RRC message including second cell configuration information for the UE. Based on the second cell configuration information, the UE may determine that all serving cell indexes of secondary serving cells configured for the UE are equal to or smaller than seven. Further, the UE may determine that all serving cell indexes of secondary serving cells configured for the UE are equal to or smaller than seven, based on a value of an activation/deactivation LCID included in a MAC header.

When all serving cell indexes of secondary serving cells configured for the UE are equal to or smaller than seven, the UE may receive, from the base station, second activation/deactivation MAC information associated with secondary serving cells configured for the UE, the second activation/deactivation MAC information including a 1-octet MAC CE and a Logical Channel Identifier associated with the 1-octet MAC CE. The 1-octet MAC CE includes one reserved field and 7 non-reserved fields. The cell configuration information includes information of a primary serving cell configured for the UE and information of at least one secondary serving cell configured for the UE, and each serving cell configured for the UE has a unique serving cell index.

A system-on-chip (SoC) for a UE may include a processor configured to: receive a Radio Resource Control (RRC) message including cell configuration information for the UE, the cell configuration information for the UE including configuration information of a maximum of 32 serving cells; receive activation/deactivation Media Access Control (MAC) information associated with secondary serving cells configured for the UE, the activation/deactivation MAC information including a 4-octet MAC control element (CE) and a Logical Channel Identifier associated with the 4-octet MAC CE, at least part of the 4-octet MAC CE being associated with an activation or deactivation of the secondary serving cells configured for the UE; and control activation/deactivation states of the secondary serving cells configured for the UE according to values of the at least part of the 4-octet MAC CE. The SoC may communicate with an RF circuit, e.g., the RF unit 2110, to receive or transmit data. The RF circuit includes an antenna so that wireless communication signals can be transmitted or received through an air interface. For example, the processor 2120 may be implemented as an SoC.

According to an exemplary embodiment, a system for a base station, may control activation of secondary serving cells for UEs. The system may include a processor, e.g., the processor 2010, and may be implemented in the base station. The system configures secondary serving cells for a first UE, a serving cell index of at least one of the secondary serving cells is greater than seven. The system transmits, to the first UE through an antenna, a Radio Resource Control (RRC) message including cell configuration information for the first UE, the cell configuration information for the first UE including configuration information of a maximum of 32 serving cells. The system sets values of at least part of a 4-octet Media Access Control (MAC) control element (CE) for controlling activation/deactivation states of the secondary serving cells configured for the first UE. Further, the system transmits to the UE, activation/deactivation MAC information associated with the secondary serving cells configured for the first UE, the activation/deactivation MAC information including the 4-octet MAC CE and a Logical Channel Identifier associated with the 4-octet MAC CE, the values of the at least part of the 4-octet MAC CE being associated with an activation or deactivation of the secondary serving cells configured for the first UE.

The system may configure secondary serving cells for a second UE, all serving cell indexes of the secondary serving cells for the second UE is equal to or smaller than seven. The system may transmit, to the second UE, an RRC message including cell configuration information for the second UE, the cell configuration information for the second UE including configuration information of a maximum of eight serving cells. The system may set values of at least part of a 1-octet MAC CE for controlling activation/deactivation states of the secondary serving cells configured for the second UE. Further, the system may transmit, to the second UE, activation/deactivation MAC information associated with the secondary serving cells configured for the second UE, the activation/deactivation MAC information associated with the secondary serving cells configured for the second UE including the 1-octet MAC CE and a Logical Channel Identifier associated with the 1-octet MAC CE, the values of the at least part of the 1-octet MAC CE being associated with an activation or deactivation of the secondary serving cells configured for the second UE.

Exemplary embodiments of the present invention may be implemented by hardware, software or a combination thereof. In a hardware configuration, the above-described functions and operations may be performed by one or more processors, such as a microprocessor, a controller, a microcontroller, or an ASIC (Application Specific Integrated Circuit), a DSP (Digital Signal Processor), a PLD (Programmable logic device), a FPGA (Field Programmable Gate Array), and/or combinations thereof configured to perform the functions and operations. In a software configuration, software or program codes to perform the functions and operations may be implemented as modules. Software may be stored in one or more memory units and may be executed by the one or more processors. It will be apparent to those of ordinary skill in the art from the description of the present invention to design, develop and implement the memory units or the processors.

While the present invention has been shown and described in connection with the embodiments, it will be apparent to those skilled in the art that modifications and variations can be made without departing from the spirit and scope of the invention as defined by the appended claims. Thus, the present invention is not limited to the foregoing embodiments and may include all the embodiments within the scope of the appended claims.

What is claimed is:

1. A method for controlling activation of secondary serving cells by a User Equipment (UE), the method comprising:
receiving, from a base station, a Radio Resource Control (RRC) message comprising cell configuration information for the UE, the cell configuration information for the UE comprising configuration information of a maximum of 32 serving cells;
receiving, from the base station, activation/deactivation Media Access Control (MAC) information associated with secondary serving cells configured for the UE, the activation/deactivation MAC information comprising a 4-octet MAC control element (CE) and a Logical Channel Identifier associated with the 4-octet MAC CE, at least part of the 4-octet MAC CE being associated with an activation or deactivation of the secondary serving cells configured for the UE; and
controlling activation/deactivation states of the secondary serving cells configured for the UE according to values of the at least part of the 4-octet MAC CE.

2. The method of claim 1, wherein a serving cell index of at least one of the secondary serving cells configured for the UE is greater than seven, and
wherein the cell configuration information for the UE indicates the serving cell index, which is greater than seven.

3. The method of claim 1, wherein each octet of the 4-octet MAC CE consists of eight bits, and
wherein the at least part of the 4-octet MAC CE is determined based on serving cell indexes of the secondary serving cells configured for the UE.

4. The method of claim 1, further comprising:
transmitting, to the base station, UE capability information comprising at least one of information of frequency bands supportable by the UE, information of frequency bands available for carrier aggregation, and information associated with a bandwidth supportable in a frequency band.

5. The method of claim 1, further comprising:
transmitting, to the base station, UE capability information comprising information indicating that the UE supports a maximum of 32 serving cells.

6. The method of claim 1, further comprising:
identifying the Logical Channel Identifier associated with the 4-octet MAC CE from a MAC header of the activation/deactivation MAC information; and
identifying the 4-octet MAC CE based on a value of the Logical Channel Identifier.

7. The method of claim 1, wherein the 4-octet MAC CE comprises one reserved field and 31 non-reserved fields, at least part of the 31 non-reserved fields being associated with the activation/deactivation states of the secondary serving cells configured for the UE.

8. The method of claim 1, further comprising:
receiving a second RRC message comprising second cell configuration information for the UE;
determining that all serving cell indexes of secondary serving cells configured for the UE are equal to or smaller than seven;
when all serving cell indexes of secondary serving cells configured for the UE are equal to or smaller than seven, receiving, from the base station, second activation/deactivation MAC information associated with secondary serving cells configured for the UE, the second activation/deactivation MAC information comprising a 1-octet MAC CE and a Logical Channel Identifier associated with the 1-octet MAC CE.

9. The method of claim 8, wherein the 1-octet MAC CE comprises one reserved field and 7 non-reserved fields.

10. The method of claim 1, wherein the cell configuration information comprises information of a primary serving cell configured for the UE and information of at least one secondary serving cell configured for the UE, and
wherein each serving cell configured for the UE has a unique serving cell index.

11. A system-on-chip (SoC) for a User Equipment (UE) to control activation of secondary serving cells, the SoC comprising:
a processor configured to:
receive a Radio Resource Control (RRC) message comprising cell configuration information for the UE, the cell configuration information for the UE comprising configuration information of a maximum of 32 serving cells;
receive activation/deactivation Media Access Control (MAC) information associated with secondary serving cells configured for the UE, the activation/deactivation MAC information comprising a 4-octet MAC control element (CE) and a Logical Channel Identifier associated with the 4-octet MAC CE, at least part of the 4-octet MAC CE being associated with an activation or deactivation of the secondary serving cells configured for the UE; and
control activation/deactivation states of the secondary serving cells configured for the UE according to values of the at least part of the 4-octet MAC CE.

12. The SoC of claim 11, wherein a serving cell index of at least one of the secondary serving cells configured for the UE is greater than seven, and
wherein the cell configuration information for the UE indicates the serving cell index, which is greater than seven.

13. The SoC of claim 11, wherein each octet of the 4-octet MAC CE consists of eight bits, and
wherein the at least part of the 4-octet MAC CE is determined based on serving cell indexes of the secondary serving cells configured for the UE.

14. The SoC of claim 11, wherein the processor is configured to generate UE capability information comprising information indicating that the UE supports a maximum of 32 serving cells.

15. The SoC of claim 11, wherein the processor is configured to identify the Logical Channel Identifier associated with the 4-octet MAC CE from a MAC header of the activation/deactivation MAC information, and to identify the 4-octet MAC CE based on a value of the Logical Channel Identifier.

16. The SoC of claim 11, wherein the 4-octet MAC CE comprises one reserved field and 31 non-reserved fields, at least part of the 31 non-reserved fields being associated with the activation/deactivation states of the secondary serving cells configured for the UE.

17. The SoC of claim 11, wherein the processor is configured to receive a second RRC message comprising second cell configuration information for the UE, and to determine, based on the second cell configuration information, that all serving cell indexes of secondary serving cells configured for the UE are equal to or smaller than seven; and
wherein, when all serving cell indexes of secondary serving cells configured for the UE are equal to or smaller than seven, the processor is configured to receive second activation/deactivation MAC information associated with secondary serving cells configured for the UE, the second activation/deactivation MAC information comprising a 1-octet MAC CE and a Logical Channel Identifier associated with the 1-octet MAC CE.

18. The SoC of claim 17, wherein the 1-octet MAC CE comprises one reserved field and 7 non-reserved fields.

19. A method for controlling activation of secondary serving cells by a system for a base station, the method comprising:
configuring secondary serving cells for a first User Equipment (UE), a serving cell index of at least one of the secondary serving cells is greater than seven;
transmitting, to the first UE, a Radio Resource Control (RRC) message comprising cell configuration information for the first UE, the cell configuration information for the first UE comprising configuration information of a maximum of 32 serving cells;
setting values of at least part of a 4-octet Media Access Control (MAC) control element (CE) for controlling activation/deactivation states of the secondary serving cells configured for the first UE; and
transmitting, to the first UE, activation/deactivation MAC information associated with the secondary serving cells configured for the first UE, the activation/deactivation MAC information comprising the 4-octet MAC CE and a Logical Channel Identifier associated with the 4-octet MAC CE, the values of the at least part of the 4-octet MAC CE being associated with an activation or deactivation of the secondary serving cells configured for the first UE.

20. The method of claim 19, further comprising:
configuring secondary serving cells for a second UE, all serving cell indexes of the secondary serving cells for the second UE is equal to or smaller than seven;
transmitting, to the second UE, an RRC message comprising cell configuration information for the second UE, the cell configuration information for the second UE comprising configuration information of a maximum of eight serving cells;
setting values of at least part of a 1-octet MAC CE for controlling activation/deactivation states of the secondary serving cells configured for the second UE; and
transmitting, to the second UE, activation/deactivation MAC information associated with the secondary serving cells configured for the second UE, the activation/deactivation MAC information associated with the secondary serving cells configured for the second UE comprising the 1-octet MAC CE and a Logical Channel Identifier associated with the 1-octet MAC CE, the values of the at least part of the 1-octet MAC CE being associated with an activation or deactivation of the secondary serving cells configured for the second UE.
